(19) United States
(12) Patent Application Publication
(10) Pub. No.: US 2012/0093543 A1
(43) Pub. Date: Apr. 19, 2012

(54) ELECTROSTATIC LATENT IMAGE DEVELOPER, METHOD FOR FORMING IMAGE, AND IMAGE FORMING APPARATUS

(75) Inventors: Miho IKEDA, Kanagawa (JP); Sakon TAKAHASHI, Kanagawa (JP); Kazuhiko ARAI, Kanagawa (JP); Haruhide ISHIDA, Kanagawa (JP); Michio TAKE, Kanagawa (JP); Kunihiko SATO, Kanagawa (JP); Yoshinori KUBO, Tokyo (JP); Fusako KIYONO, Kanagawa (JP)

(73) Assignee: FUJI XEROX CO., LTD., Tokyo (JP)

(21) Appl. No.: 13/204,316

(22) Filed: Aug. 5, 2011

(30) Foreign Application Priority Data
Oct. 15, 2010 (JP) 2010-232876

(51) Int. Cl. G03G 15/09

(52) U.S. Cl. 399/267

(57) ABSTRACT

An electrostatic latent image developer contains a toner having a volume-average particle diameter of about 2.0 μm to about 6.5 μm, and a carrier whose average magnetization per carrier particle at an applied magnetic field of 1 kilooersted is about 3.0×10⁻¹⁶ Am²/particle to about 3.0×10⁻¹⁵ Am²/particle, wherein the electrostatic latent image developer is used in an image forming apparatus including an image-carrying member having a top surface layer composed of a cured film containing fluorocarbon resin particles, a developing unit that develops an electrostatic latent image formed on the image-carrying member to form a toner image by bringing a magnetic brush formed of the electrostatic latent image developer and having a brush roughness of about 300 μm to about 850 μm into contact with the image-carrying member, and a cleaning unit that includes a cleaning blade.

### CROSS-REFERENCE TO RELATED APPLICATIONS

This application is based on and claims priority under 35 USC 119 from Japanese Patent Application No. 2010-232876 filed Oct. 15, 2010.

### BACKGROUND

(i) Technical Field

The present invention relates to an electrostatic latent image developer, a method for forming an image, and an image forming apparatus.

(ii) Related Art

Electrophotography is widely used in copy machines, printers, and the like.

### SUMMARY

According to an aspect of the invention, there is provided an electrostatic latent image developer containing a toner having a volume-average particle diameter of about 2.0 μm or more and about 6.5 μm or less; and a carrier whose average magnetization per carrier particle at an applied magnetic field of 1 kilooersted is about 3.0×10⁻¹⁶ Am²/particle or more and about 3.0×10⁻¹⁵ Am²/particle or less, in which the electrostatic latent image developer is used in an image forming apparatus including an image-carrying member having a top surface layer composed of a cured film containing fluorocarbon resin particles, a charging unit that charges a surface of the image-carrying member, a latent image-forming unit that exposes the charged surface of the image-carrying member to form an electrostatic latent image, a developing unit that contains an electrostatic latent image developer therein and that includes a developer-carrying member, the developing unit being configured to develop the electrostatic latent image formed on the image-carrying member to form a toner image by bringing a magnetic brush formed on the surface of the developer-carrying member into contact with the image-carrying member, the magnetic brush being formed of the electrostatic latent image developer and having a brush roughness of about 300 μm or more and about 850 μm or less, a transfer unit that transfers the toner image formed on the image-carrying member to a recording medium, and a cleaning unit that includes a cleaning blade configured to contact the surface of the image-carrying member to clean the surface of the image-carrying member.

### BRIEF DESCRIPTION OF THE DRAWINGS

Exemplary embodiments of the present invention will be described in detail based on the following figures, wherein:

FIG. 1 is a schematic structural view illustrating an image forming apparatus according to an exemplary embodiment;

FIG. 2 is a schematic structural view illustrating an image forming apparatus according to another exemplary embodiment;

FIG. 3 is a schematic view illustrating an operation of a carrier (magnetic brush) of a developer according to an exemplary embodiment;

FIG. 4 is a schematic view illustrating an operation of a carrier (magnetic brush) of a developer according to an exemplary embodiment;

FIG. 5 is a schematic view illustrating an operation of a carrier (magnetic brush) of an'existing developer;

FIG. 6 is a schematic view illustrating an operation of a carrier (magnetic brush) of an existing developer;

FIG. 7 is a schematic view illustrating a method for measuring a brush roughness of a magnetic brush of a developer according to an exemplary embodiment;

FIGS. 8A to 8E are schematic views illustrating a method for measuring a brush roughness of a magnetic brush of a developer according to an exemplary embodiment;

FIG. 9 is a schematic view illustrating a method for measuring a brush roughness of a magnetic brush of a developer according to an exemplary embodiment;

FIG. 10 is a schematic view of a magnetic brush in Example 1, when viewed from an end thereof;

FIG. 11 is a schematic view of a magnetic brush in Comparative Example 1, when viewed from an end thereof;

FIG. 12 is a schematic view of a magnetic brush in Example 1, when viewed from a side surface thereof;

FIG. 13 is a schematic view of a magnetic brush in Comparative Example 1, when viewed from a side surface thereof;

FIG. 14 is a graph showing a relationship between the number of rotations of a photoreceptor and a contact angle of a surface of the photoreceptor (contact angle to water) in Example 1 and Comparative Example 1; and

FIG. 15 is a graph showing a relationship between the coating ratio of a lubricant to a surface of a photoreceptor and a contact angle of the surface of the photoreceptor (contact angle to water).

### DETAILED DESCRIPTION

An exemplary embodiment of the present invention will now be described.

An image forming apparatus according to this exemplary embodiment includes an image-carrying member; a charging unit that charges a surface of the image-carrying member; a latent image-forming unit that exposes the charged surface of the image-carrying member to form an electrostatic latent image; a developing unit that contains an electrostatic latent image developer therein and that includes a developer-carrying member, the developing unit being configured to develop the electrostatic latent image formed on the image-carrying member to form a toner image by bringing a magnetic brush formed on the surface of the developer-carrying member and formed of the electrostatic latent image developer into contact with the image-carrying member; a transfer unit that transfers the toner image formed on the image-carrying member to a recording medium; and a cleaning unit that includes a cleaning blade configured to contact the surface of the image-carrying member to clean the surface of the image-carrying member.

Herein, the term “magnetic brush” refers to a state where plural carrier particles to which a toner adheres are linearly linked on the surface of the developer-carrying member by means of the magnetic force of a magnet provided inside the developer-carrying member to form carrier chains.

In addition, an image-carrying member including a top surface layer composed of a cured film containing fluorocarbon resin particles is used as the image-carrying member.

Furthermore, as the electrostatic latent image developer (hereinafter may be simply referred to as “developer”), a developer containing a toner having a volume-average particle diameter of 2.0 μm or more and 6.5 μm or less, or about 2.0 μm or more and about 6.5 μm or less (hereinafter may be referred to as “toner having a small particle diameter”) and a carrier whose average magnetization per particle at an applied magnetic field of 1 kilooersted is 3.0×10⁻¹⁶ Am²/particle or more and 3.0×10⁻¹⁵ Am²/particle or less, or about 3.0×10⁻¹⁶ Am²/particle or more and about 3.0×10⁻¹⁵ Am²/particle or less (hereinafter may be referred to as “weakly magnetized carrier”) is used. Furthermore, a brush roughness of the magnetic brush formed of the electrostatic latent image developer and formed on the surface of the developer-carrying member is 300 μm or more and 850 μm or less, or about 300 μm or more and about 850 μm or less.

Note that the term “volume-average particle diameter of a toner” refers to a volume-average particle diameter of toner particles contained in the toner.

Recently, toners having small particle diameters have been used in order to form high-definition images. In such a toner having a small particle diameter, with a decrease in the diameter, the amount of charge per particle of the toner decreases. Accordingly, an electrostatic adhesive force to an image-carrying member decreases. On the other hand, a non-electrostatic adhesive force such as the van der Waals force (i.e., intermolecular force) to the image-carrying member increases. Consequently, it is believed that transferring such a toner having a small particle diameter with a transfer electric field will become difficult, as compared with a toner having a large particle diameter, and thus generation of fog tends to occur.

In order to address the above problem, a technology is known in which fluorocarbon resin particles are incorporated into a top surface layer of an image-carrying member. The image-carrying member is used while scraping off the top surface layer with a cleaning blade for the purpose of removing discharge products, a residual toner, and the like adhering to the surface. When fluorocarbon resin particles are incorporated into the top surface layer of the image-carrying member, the top surface layer is scraped off with the cleaning blade while the fluorocarbon resin particles are sequentially exposed, and the exposed fluorocarbon resin particles are spread by pressure. Thus, the fluorocarbon resin is uniformly applied over the entire surface of the image-carrying member. It is believed that, this uniform application of the fluorocarbon resin realizes low surface energy of the surface of the image-carrying member, thereby reducing a non-electrostatic adhesive force between the image-carrying member and a toner and suppressing the generation of fog.

It is known that, for the purpose of achieving a long life, a top surface layer (for example, a protective layer) composed of a cured film containing fluorocarbon resin particles is provided as a top surface layer of an image-carrying member. However, it was found that when fluorocarbon resin particles are incorporated into such a top surface layer composed of a cured film, streak-like fog is generated.

The mechanism of this generation of streak-like fog is believed to be as follows. Since the top surface layer is composed of a cured film, the amount of scraping (the amount of abrasion) by the cleaning blade decreases, and thus the amount of exposure of the fluorocarbon resin particles per unit time (per the number of rotations of the image-carrying member) also decreases. Consequently, the exposed fluorocarbon resin particles are spread by the cleaning blade only in the circumferential direction of the image-carrying member, and are thus applied in streak-like shapes without being spread in the axial direction thereof. More specifically, the fluorocarbon resin is not applied over the entire surface of the image-carrying member, and regions where the fluorocarbon resin is not applied are formed in streak-like shapes in the circumferential direction of the image-carrying member.

When a toner having a small particle diameter is used in such a state, the generation of streak-like fog significantly appears on regions of an image where the fluorocarbon resin is not applied because the non-electrostatic adhesive force of the toner having the small particle diameter to the image-carrying member is large.

In this exemplary embodiment, the brush roughness of the magnetic brush formed of the electrostatic latent image developer and formed on the surface of the developer-carrying member is controlled to be 300 μm or more and 850 μm or less, or about 300 μm or more and about 850 μm or less. This means that the density of the magnetic brush is high and the length of the brush is even.

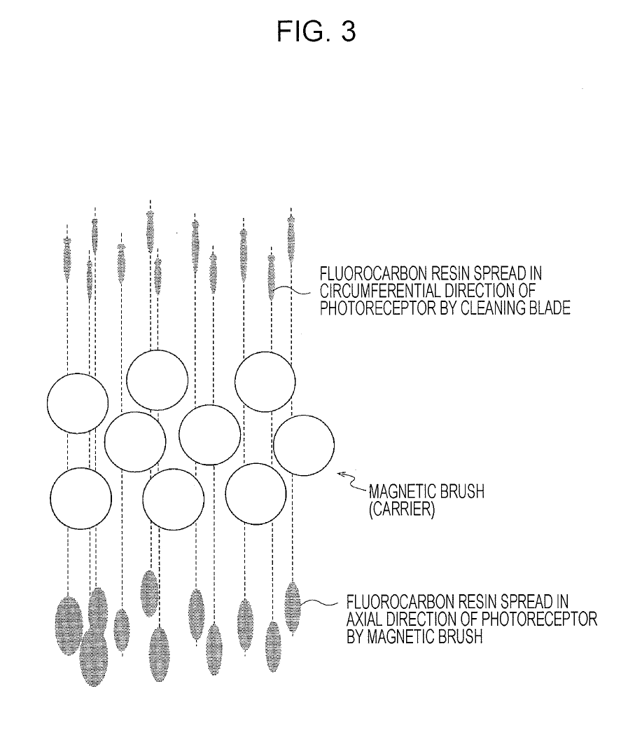

Such a magnetic brush has a high density and an even brush length. Therefore, in development, the probability in which the magnetic brush contracts a fluorocarbon resin applied onto the image-carrying member in streak-like shapes, the fluorocarbon resin being formed of fluorocarbon resin particles exposed by the cleaning blade, increases. It is believed that, consequently, the fluorocarbon resin applied onto the image-carrying member in streak-like shapes is applied so as to spread in the axial direction of the image-carrying member by vibrations of the magnetic brush in the axial direction of the image-carrying member. It is believed that, as a result, the fluorocarbon resin is easily uniformly applied over the entire surface of the image-carrying member (refer to FIG. 3).

It is believed that the formation of a magnetic brush having a brush roughness in the above range is realized by using the above-described weakly magnetized carrier.

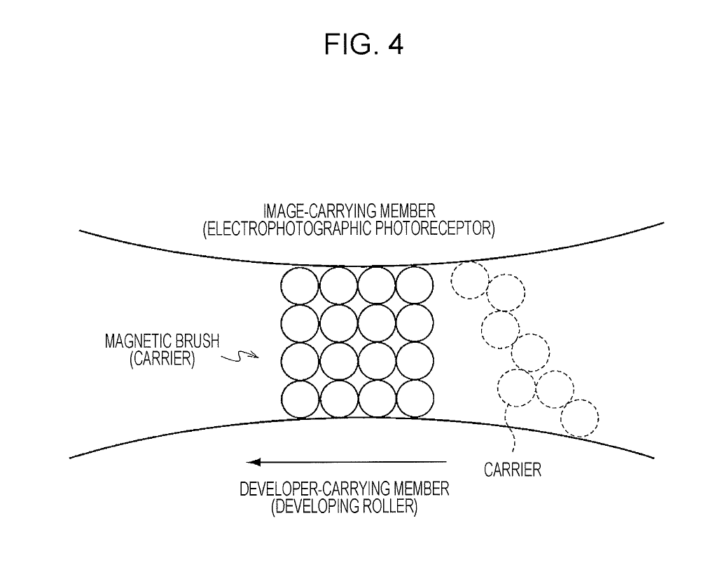

The reason for this is believed to be as follows. In the case where such a weakly magnetized carrier is used, when a developer carried on a developer-carrying member enters a development region (region where the developer-carrying member faces the image-carrying member), linked carrier particles are easily disconnected or easily slide in the development region because the action of the attractive force between the carrier particles is small. As a result, rearrangement of the carrier particles easily occurs, and the density of the magnetic brush becomes high (refer to FIG. 4). In addition, it is also believed that the length of the magnetic brush becomes easily even. Accordingly, when the weakly magnetized carrier is used, the magnetic brush having a brush roughness in the above range is believed to be formed.

In addition, it is believed that, in the weakly magnetized carrier, the action of the attractive force between the carrier particles is small and thus the magnetic brush becomes flexible. Therefore, the vibration width of the magnetic brush in the axial direction of the image-carrying member increases, and the degree of spread of the fluorocarbon resin in the axial direction of the image-carrying member also increases. Consequently, the fluorocarbon resin is easily applied over the entire surface of the image-carrying member.

In contrast, when a magnetic brush having a low density, uneven brush length, and a brush roughness that is outside the above range is formed, that is, when a carrier having a high average magnetization per carrier particle (for example, a carrier having an average magnetization per carrier particle of more than 3.0×10⁻¹⁵ Am²/particle or more than about 3.0×10⁻¹⁵ Am²/particle: hereinafter also referred to as “carrier having a high magnetization per particle”) is used, the above phenomenon does not tend to occur.

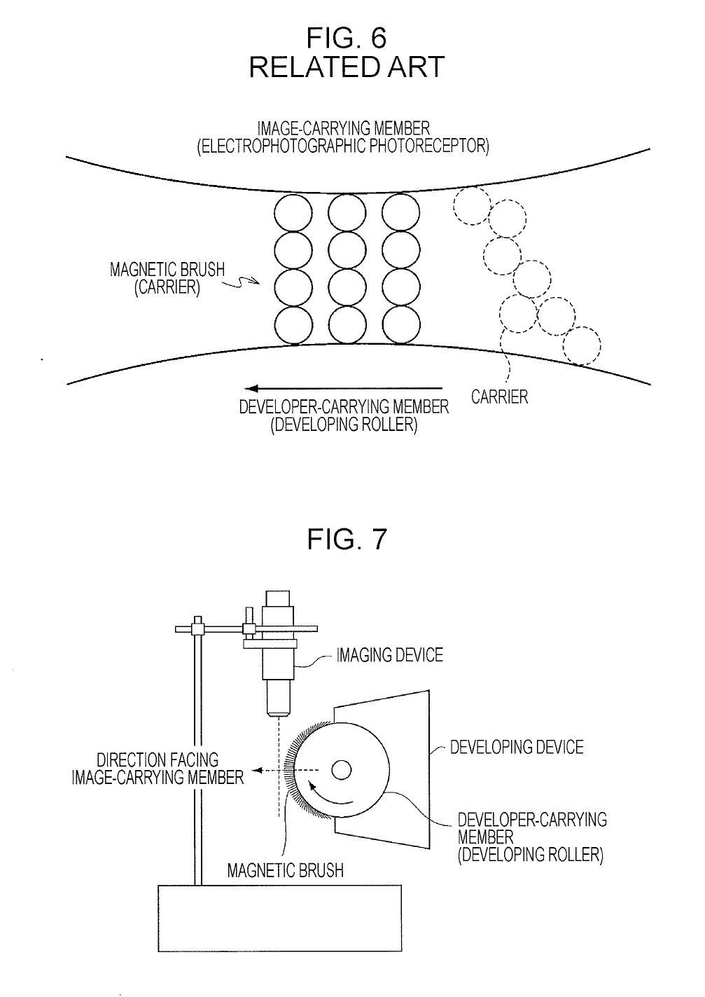

In the case where such a carrier having a high magnetization per particle is used, when a developer carried on a developer-carrying member enters a development region (region where the developer-carrying member faces the image-carrying member), linked carrier particles are not easily disconnected or do not easily slide in the development region because the action of the attractive force between the carrier particles is large. As a result, rearrangement of the carrier particles does not tend to occur, and the density of the magnetic brush becomes low (refer to FIG. 6). In addition, it is believed that the length of the magnetic brush does not easily become even. Accordingly, when the carrier having a high magnetization per particle is used, the magnetic brush having a brush roughness that is outside the above range is believed to be formed.

Such a magnetic brush having a brush roughness exceeding the above range has a low density and an uneven brush length. Therefore, it is believed that, in development, the probability in which the magnetic brush contacts a fluorocarbon resin that is applied by spreading in the circumferential direction of the image-carrying member by the cleaning blade is low.

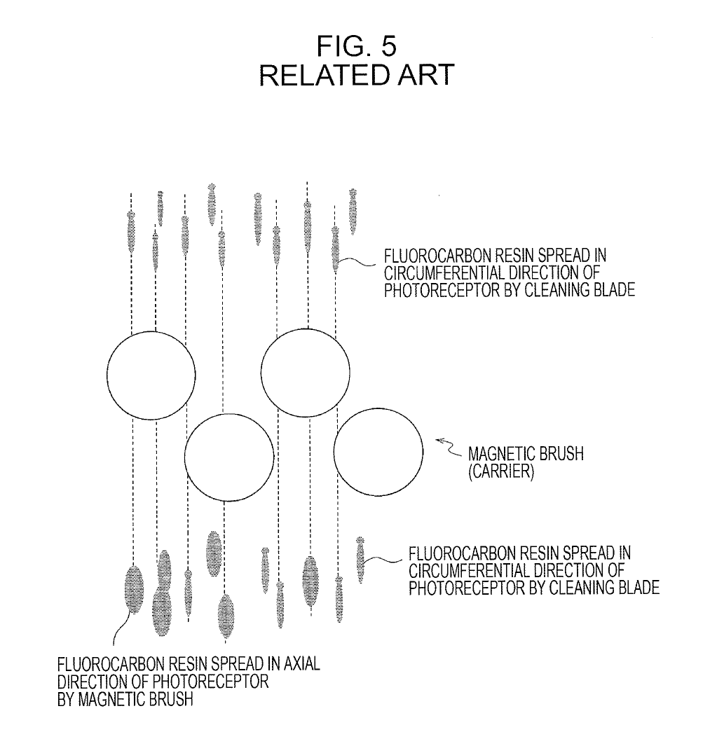

In addition, in the carrier having a high magnetization per particle, the action of the attractive force between the carrier particles is large and thus the magnetic brush becomes rigid. Therefore, the vibration width of the magnetic brush in the axial direction of the image-carrying member decreases, and the degree of spread of the fluorocarbon resin in the axial direction of the image-carrying member is small, even when the magnetic brush contacts the fluorocarbon resin. As a result, it is believed that the fluorocarbon resin is not easily applied over the entire surface of the image-carrying member (refer to FIG. 5).

Accordingly, in this exemplary embodiment, in an image forming apparatus including an image-carrying member having a top surface layer composed of a cured film containing fluorocarbon resin particles, it is possible to form an image in which the generation of streak-like fog due to uneven distribution of a fluorocarbon resin component and the like on the surface of the image-carrying member is suppressed even when a toner having a small particle diameter, such as a toner having a volume-average particle diameter of 2.0 μm or more and 6.5 μm or less, or about 2.0 μm or more and about 6.5 μm or less, is used.

It is believed that the generation of streak-like fog is suppressed by increasing the content of the fluorocarbon resin particles. However, when the content of the fluorocarbon resin particles is increased, light scattering tends to occur in the layer. As a result, reproducibility of lines and characters decreases and granularity also decreases, which may easily result in image defects other than the generation of streak-like fog (for example, at a content of the fluorocarbon resin particles of more than 20% by mass, and more significantly more than 30% by mass).

Accordingly, in this exemplary embodiment, an image in which the generation of streak-like fog is suppressed is obtained while reducing the content of the fluorocarbon resin particles (to, for example, 30% by mass or less, and more preferably 20% by mass).

Herein, the brush roughness of the magnetic brush is 300 μm or more and 850 μm or less, or about 300 μm or more and about 850 μm or less, preferably 350 μm or more and 800 μm or less, or about 350 μm or more and about 800 μm or less, and more preferably 400 μm or more and 750 μm or less, or about 400 μm or more and about 750 μm or less. When the brush roughness of this magnetic brush is less than 300 μm or less than about 300 μm, the average magnetization per carrier particle and the particle diameter are excessively small and carrier scattering occurs. On the other hand, when the brush roughness of the magnetic brush exceeds 850 μm or about 850 μm, the above-described generation of streak-like fog is not suppressed.

It is believed that the brush roughness of the magnetic brush is controlled not only by the average magnetization per carrier particle but also by the magnetic force of a developing roller, a surface roughness, and a member for controlling the length of the magnetic brush. However, these factors are not significantly varied within setting ranges of a developing device that is used, and the brush roughness significantly varies depending on the average magnetization per carrier particle. Thus, the average magnetization per carrier particle is believed to be a major control factor.

A method for measuring the brush roughness of a magnetic brush is as follows.

First, as illustrated in FIG. 7, a developing device is detached from an apparatus and set in an imaging device.

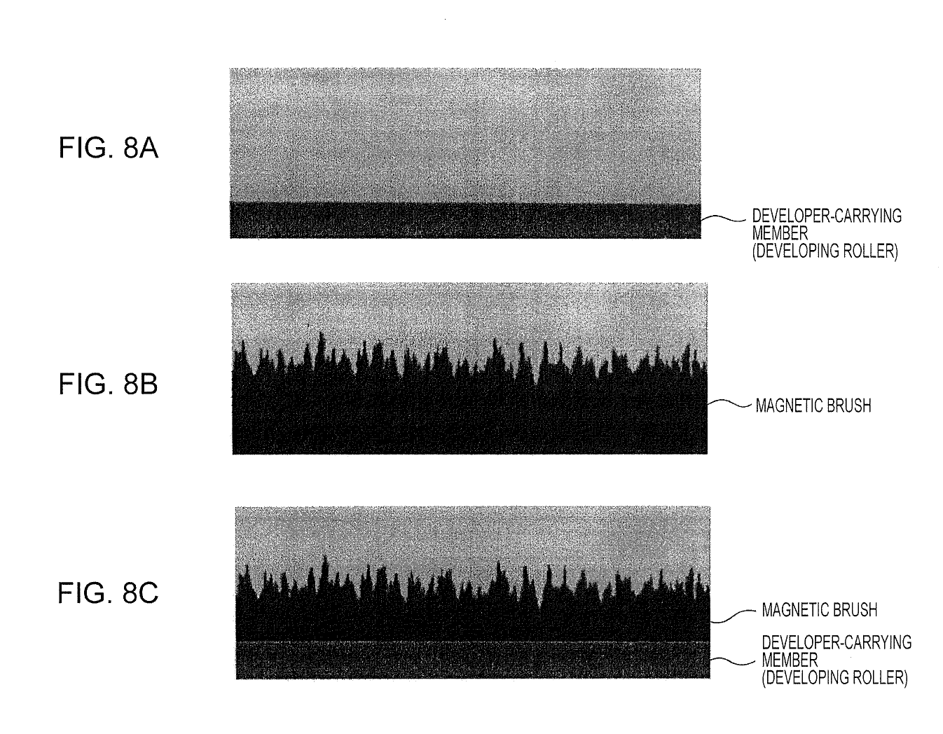

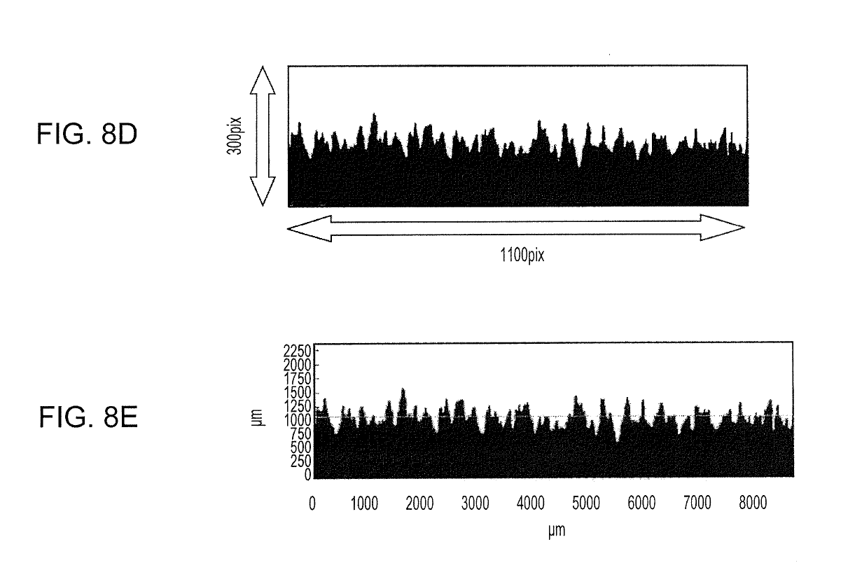

A developer on a developer-carrying member (developing roller) is then removed, and an image of the surface of the developer-carrying member itself is captured (refer to FIG. 8A: image 1).

Next, the developer-carrying member is rotated, and an image of a magnetic brush formed on the surface of the developer-carrying member is captured (refer to FIG. 8B: image 2).

Herein, in the image capturing, a Keyence VHX600 digital microscope (lens optical magnification: ×0.6, captured image size: 600×800 pix, field of view: 9.2×12.2 mm) is used as then imaging device. For the observation, an image is captured from a tangential direction of a main pole position of the developing roller.

Next, the image 1 of the developing roller shown in FIG. 8A and the image 2 of the magnetic brush shown in FIG. 8B are superimposed using image processing software “Photoshop” to prepare an image 3 of a magnetic brush in a development region (at a position facing an image-carrying member) (refer to FIG. 8C: image 3).

Next, an image of 300 pix in the vertical direction x 1,100 pix in the horizontal direction is cut out from the image 3 of the magnetic brush shown in FIG. 8C in the development region (at the position facing the image-carrying member) at a boundary of a developer-carrying member surface and at a boundary of a sleeve surface to prepare a binary image (black and white image) (refer to FIG. 8D: image 4).

Next, binary information of each pixel of the binary image is extracted and read, and conversion is conducted from pix to μm (1 pix=7.9 μm) (refer to FIG. 8E: image 5).

Next, the 10-point average roughness is calculated in accordance with JIS B 0601-2001 Rz_{JIS} on the basis of the image that has been converted to the unit of μm. This 10-point average roughness is defined as the brush roughness of the magnetic brush.

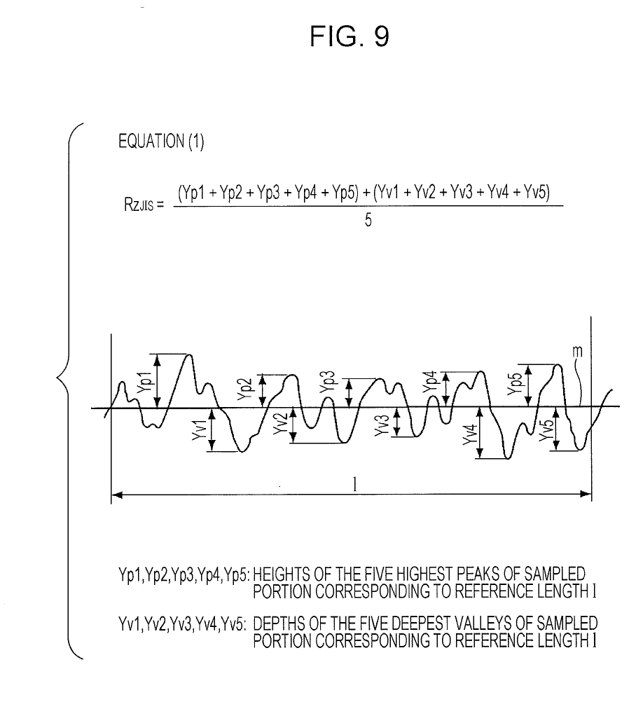

The 10-point average roughness is calculated in accordance with JIS B 0601-2001 Rz_{JIS} as follows. As illustrated in FIG. 9, only a reference length is sampled from a roughness profile in a direction of a mean line of the roughness profile. The sum of the average of the absolute values of the heights (Yp) of the highest peak to the fifth highest peak and the average of the absolute values of the depths (Yv) of the deepest valley to the fifth deepest valley, the heights and depths being measured in the vertical magnification direction from the mean line of the sampled portion, is determined. The 10-point average roughness is calculated from equation (1) shown in FIG. 9 on the basis of this value.

The exemplary embodiment will now be described with reference to the drawings.

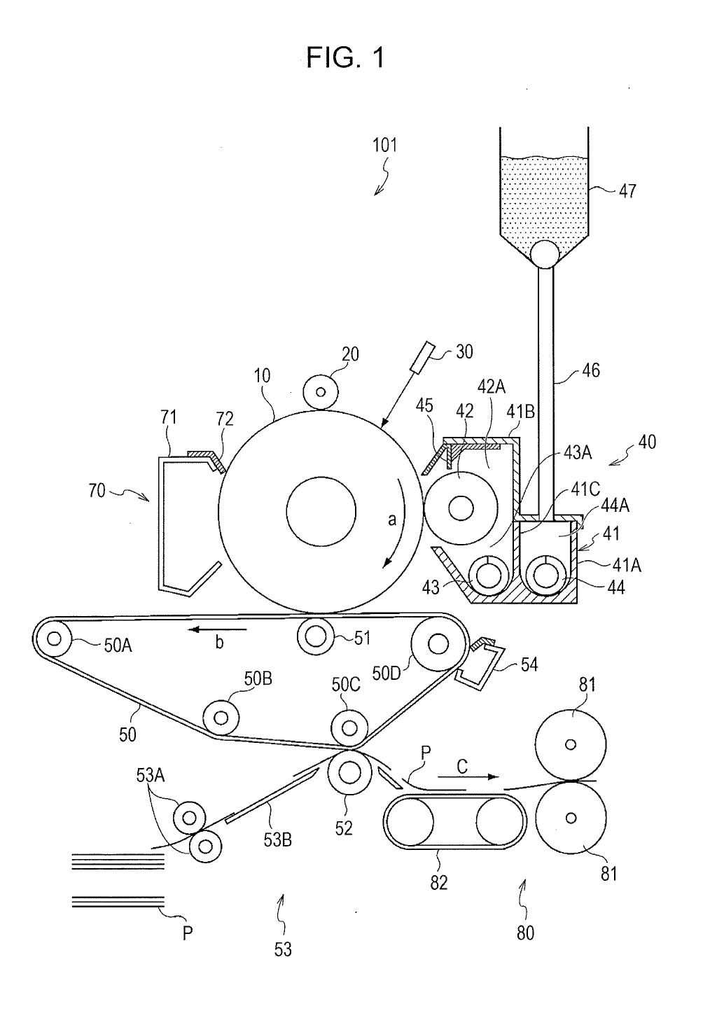

FIG. 1 is a schematic structural view illustrating an image forming apparatus according to this exemplary embodiment.

As illustrated in FIG. 1, an image forming apparatus 101 according to this exemplary embodiment includes, for example, an electrophotographic photoreceptor 10 (an example of an image-carrying member) that rotates in the clockwise direction as shown by an arrow a, a charging device 20 (an example of charging unit) that is arranged above the electrophotographic photoreceptor 10 so as to face the electrophotographic photoreceptor 10 and that charges a surface of the electrophotographic photoreceptor 10, an exposure device 30 (an examples of a latent image-forming unit) that exposes the surface of the electrophotographic photoreceptor. 10 charged by the charging device 20 to form an electrostatic latent image, a developing device 40 (an example of a developing unit) that causes a toner contained in a developer to adhere, by a contact developing method, to the electrostatic latent image formed by the exposure device 30 to form a toner image on the surface of the electrophotographic photoreceptor 10, a belt-shaped intermediate transfer member 50 that travels in the direction shown by an arrow b while being in contact with the electrophotographic photoreceptor 10 and that transfers the toner image formed on the surface of the electrophotographic photoreceptor 10, and a cleaning device 70 (an example of a cleaning unit) that cleans the surface of the electrophotographic photoreceptor 10.

The charging device 20, the exposure device 30, the developing device 40, the intermediate transfer member 50, and the cleaning device 70 are arranged in the clockwise direction on a circumference surrounding the electrophotographic photoreceptor 10.

The intermediate transfer member 50 is held by support rollers 50A and 50B, a back-up roller 50C, and a driving roller 50D from the inside while a tension is applied, and is driven in the direction shown by the arrow b with a rotation of the driving roller 50D. A first transfer device 51 is arranged at a position inside the intermediate transfer member 50 and corresponding to the electrophotographic photoreceptor 10. The first transfer device 51 charges the intermediate transfer member 50 to a polarity different from a charging polarity of the toner so that the toner on the electrophotographic photoreceptor 10 is adsorbed on the outer surface of the intermediate transfer member 50. A second transfer device 52 is arranged outside the lower portion of the intermediate transfer member 50 so as to face the back-up roller 50C. The second transfer device 52 charges a recording sheet P (an example of a recording medium) to a polarity different from the charging polarity of the toner so that the toner image formed on the intermediate transfer member 50 is transferred to the recording sheet P. Note that these members for transferring the toner image formed on the electrophotographic photoreceptor 10 to the recording sheet P correspond to an example of a transfer unit.

Furthermore, a recording sheet supply device 53 that supplies the recording sheet P to the second transfer device 52 and a fixing device 80 that fixes the toner image while transporting the recording sheet P on which the toner image has been formed in the second transfer device 52 are arranged below the intermediate transfer member 50.

The recording sheet supply device 53 includes a pair of transport rollers 53A and a guiding plate 53B that guides the recording sheet P transported by the transport rollers 53A toward the second transfer device 52. The fixing device 80 includes fixing rollers 81 and a transport belt 82 that transports the recording sheet P towards the fixing rollers 81. The fixing rollers 81 are a pair of heat rollers that fix the toner image by heating and pressing the recording sheet P, to which the toner image has been transferred by the second transfer device 52.

The recording sheet P is transported by the recording sheet supply device 53, the second transfer device 52, and the fixing device 80 in the direction shown by an arrow c.

Furthermore, an intermediate transfer member cleaning device 54 is provided on the intermediate transfer member 50. The intermediate transfer member cleaning device 54 includes a cleaning blade for removing a toner remaining on the intermediate transfer member 50 after the toner image is transferred to the recording sheet P in the second transfer device 52.

Components of the image forming apparatus 101 according to this exemplary embodiment will now be described in detail. Developer

The developer is a two-component developer containing a toner and a carrier. The above-described weakly magnetized carrier is used as the carrier.

First, the toner will be described.

The toner includes toner particles containing, for example, a binder resin, a colorant, and, as required, other additives such as a releasing agent; and if necessary, external additives.

The toner particles will be described.

Examples of the binder resin include, but are not particularly limited to, homopolymers and copolymers of styrenes such as styrene and chlorostyrene, monoolefins such as ethylene, propylene, and butylene, diolefins such as isoprene, vinyl esters such as vinyl acetate, vinyl propionate, vinyl benzoate, and vinyl butyrate, α-methylene aliphatic monocarboxylic acid esters such as methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate, vinyl ethers such as vinyl methyl ether, vinyl ethyl ether, and vinyl butyl ether, vinyl ketones such as vinyl methyl ketone, vinyl hexyl ketone, and vinyl isopropenyl ketone, and polyester resins obtained by polycondensation of a dicarboxylic acid and a diol.

Examples of the particularly typical binder resin include polystyrene, styrene-alkyl acrylate copolymers, styrene-alkyl methacrylate copolymers, styrene-acrylonitrile copolymers, styrene-butadiene copolymers, styrene-maleic anhydride copolymers, polyethylene resins, polypropylene resins, and polyester resins.

Examples of the typical binder resin include polyurethanes, epoxy resins, silicone resins, polyamides, modified rosin, and paraffin wax.

Examples of the typical colorant include magnetic powders such as a magnetite powder and a ferrite powder, carbon black, aniline blue, Calco Oil Blue, chrome yellow, ultramarine blue, Du Pont Oil Red, quinoline yellow, methylene blue chloride, phthalocyanine blue, malachite green oxalate, lamp black, rose bengal, C. I. Pigment Red 48:1, C. I. Pigment Red 122, C. I. Pigment Red 57:1, C. I. Pigment Yellow 97, C. I. Pigment Yellow 17, C. I. Pigment Blue 15:1 and C. I. Pigment Blue 15:3.

Examples of the other additives include releasing agents, magnetic substances, charge control agents, and inorganic powders.

Examples of the releasing agents include, but are not particularly limited to, hydrocarbon wax; natural wax such as carnauba wax, rice wax, and candelilla wax; synthetic or mineral/petroleum wax such as montan wax; ester wax such as fatty acid esters and montanic acid esters.

Characteristics of the toner particles will now be described.

The toner particles preferably have an average shape factor (a number average of a shape factor represented by Shape factor=(ML²/A)×(π/4)×100 wherein ML represents the maximum length of a particle and A represents a projected area of the particle) of 100 or more and 150 or less, more preferably 105 or more and 145 or less, and still more preferably 110 or more and 140 or less.

Furthermore, the toner particles have a volume-average particle diameter D50ᵥ of 2.0 μm or more and 6.5 μm or less, or about 2.0 μm or more and about 6.5 μm or less, preferably 2.0 μm or more and 5.5 μm or less, or about 2.0 μm or more and about 5.5 μm or less, and more preferably 2.0 μm or more and 4.5 μm or less, or about 2.0 μm or more and about 4.5 μm or less. The lower limit of the volume-average particle diameter D50, is preferably 2.5 μm or more, and more preferably 3.0 μm or more.

When the volume-average particle diameter D50ᵥ of the toner particles is within the above range, the generation of the streak-like fog is suppressed.

By reducing the particle diameter of the toner particles, granularity of an image (image quality) is improved. However, if the volume-average particle diameter of the toner particles is smaller than 2.0 μm or smaller than about 2.0 μm, the charge per toner particle is excessively small, which may cause fog and transfer failure.

Herein, a method for measuring the volume-average particle diameter D50ᵥ of toner particles is as follows.

First, 0.5 mg or more and 50 mg or less of measurement sample is added to 2 mL of a 5 mass % aqueous solution of a surfactant (preferably, sodium alkylbenzene sulfonate) functioning as a dispersant, and the resulting mixture is added to 100 mL or more and 150 mL or less of an electrolyte solution. A dispersion treatment of this electrolyte solution in which the measurement sample is suspended is conducted for about one minute with an ultrasonic dispersion device. A particle size distribution of particles having a particle diameter of 2.0 μm or more and 60 μm or less is measured with a Coulter Multisizer II (manufactured by Beckman Coulter, Inc.) using an aperture having an aperture diameter of 100 μm. The number of particles measured is 50,000.

The obtained particle size distribution is expressed as a volume-based cumulative distribution from the smaller particle diameter side for each divided particle size range (channel). A particle diameter providing 50% accumulation is defined as the volume-average particle diameter D50ᵥ.

The external additives will now be described. Examples of the external additives include inorganic particles. Examples of the inorganic particles include particles of SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

The surfaces of the external additives may be subjected to a hydrophobizing treatment in advance. The hydrophobizing treatment is conducted by, for example, immersing inorganic particles in a hydrophobizing agent. Examples of the hydrophobizing agent include, but are not particularly limited to, silane coupling agents, silicone oil, titanate coupling agents, and aluminum coupling agents. These hydrophobizing agents may be used alone or in combination of two or more compounds.

A method for producing a toner will now be described.

The toner particles are not particularly limited by a production method thereof. Toner particles used in this exemplary embodiment include those produce by, for example, a kneading/pulverizing method in which a binder resin, a colorant, a releasing agent, and if necessary, a charge control agent and other components are kneaded, pulverized, and classified; a method in which the shape of particles obtained by the kneading/pulverizing method is changed by a mechanical impact or thermal energy; an emulsion polymerization/aggregation method in which a polymerizable monomer of a binder resin is subjected to emulsion polymerization, the resulting dispersion liquid and a dispersion liquid of a colorant, a releasing agent, and if necessary, a charge control agent and other components are mixed, and the mixture is aggregated and coalesced to obtain toner particles; a suspension polymerization method in which a polymerizable monomer for obtaining a binder resin and a solution of a colorant, a releasing agent, and if necessary, a charge control agent and other components are suspended in an aqueous solvent, and polymerization is conducted; and a dissolution/suspension method in which a binder resin, and a solution of a colorant, a releasing agent, and if necessary, a charge control agent and other components are suspended in an aqueous solvent, and granulation is conducted.

Alternatively, other known production methods may be employed. For example, the toner particles obtained by any of the above methods may be used as a core, and aggregated particles may further be caused to adhere and coalesce so that the resulting toner particles each have a core-shell structure. From the standpoint of the shape control, and the particle size distribution control, the suspension polymerization method, the emulsion polymerization/aggregation method, and the dissolution/suspension method in which toner particle are produced in an aqueous solvent are preferable, and the emulsion polymerization/aggregation method is particularly preferable.

The toner is produced by mixing the above toner particles and the above-described external additives with a Henschel mixer, a V-blender, or the like. When the toner particles are produced by a wet method, the external additives may be mixed in the wet method.

Next, the carrier will be described.

The carrier has an average magnetization per carrier particle of 3.0×10⁻¹⁶ Am²/particle or more and 3.0×10⁻¹⁵ Am²/particle or less, or about 3.0×10⁻¹⁶ Am²/particle or more and about 3.0×10⁻¹⁵ Am²/particle or less (preferably 3.5×10⁻¹⁶ Am²/particle or more and 2.5×10⁻¹⁵ Am²/particle or less, or about 3.5×10⁻¹⁶ Am²/particle or more and about 2.5×10⁻¹⁵ Am²/particle or less, and more preferably 4.0×10⁻¹⁶ Am²/particle or more and 2.0×10⁻¹⁵ Am²/particle or less, or about 4.0×10^{-16 A}m²/particle or more and about 2.0×10⁻¹⁵ Am²/particle or less) at an applied magnetic field of 1 kilooersted.

Note that 1 [Oersted: Oe]=10³/4π [A/m]

When this average magnetization is less than 3.0×10⁻¹⁶ Am²/particle, or less than about 3.0×10⁻¹⁶ Am²/particle, the action of an attractive fotce between carrier particles is excessively weak. As a result, a developing property is decreased on the surface layer of the magnetic brush (on the side contacting the image-carrying member), and carrier scattering occurs. On the other hand, when the average magnetization is more than 3.0×10⁻¹⁵ Am²/particle or more than about 3.0×10⁻¹⁵ Am²/particle, as described above, the brush roughness of the magnetic brush to be formed is excessively rough, and streak-like fog is generated.

Herein, the average magnetization as per carrier particle at an applied magnetic field of 1 kilooersted is represented by the following formula.

Formula: σs=σ×4πr³ρ/(3×10¹²)
σ: Magnetization of carrier (Am²/kg)
r: Volume-average particle diameter D50ᵥ (μm) of carrier
ρ: True specific gravity (g/cm³) of carrier (core material in the case of a coated carrier)

The magnetization of the carrier is, for example, preferably 30 Am²/kg or more and 80 Am²/kg or less, more preferably 40 Am²/kg or more and 75 Am²/kg or less, and still more preferably 40 Am²/kg or more and 70 Am²/kg or less.

In the case of a coated carrier, the magnetization of the carrier is adjusted by the type, the size etc. of magnetic powder used. In the case of a magnetic powder-dispersed carrier, the magnetization of the carrier is adjusted by the type, the amount etc. of magnetic powder used.

Herein, the magnetization of the carrier (Am²/kg) is a value measured by a BH tracer method in a magnetic field of 1,000 Oersted with a vibration sample method (VSM) measuring device. A vibration sample-type magnetometer VSM P10 manufactured by Toei Industry Co., Ltd. is used as the measuring device.

The volume-average particle diameter D50ᵥ of the carrier is, for example, preferably 15 μm or more and 35 μm or less, more preferably 18 μm or more and 32 μm or less, and still more preferably 20 μm or more and 30 μm or less.

In addition, in the volume-average particle size distribution index GSDv of the carrier, for example, the proportion of carrier particles having a particle diameter of 45 μm or more is preferably 10% or less (more preferably 8% or less, and still more preferably 5% or less) of all the carrier particles.

It is desirable that the volume-average particle size distribution index GSDv of the carrier satisfy the above relationship. This is because, when the amount of coarse particles (carrier particles having a particle diameter of 45 μm or more) is excessively large, the brush roughness of the magnetic brush tends to increase, and streak-like fog is easily generated.

The volume-average particle diameter D50ᵥ and volume-average particle size distribution index GSDv of a carrier are determined by measuring with an aperture diameter of 100 μm using a laser scattering particle size analyzer (MICROTRACK, manufactured by Nikkiso Co., Ltd.). In this case, the measurement is conducted after a carrier is dispersed in an aqueous electrolyte solution (aqueous ISOTON solution) and then dispersed for 30 seconds or more with ultrasonic waves.

A volume-based cumulative distribution curve is drawn from the smaller particle diameter side for each particle size range (channel) divided on the basis of the particle size distribution of the carrier measured with the laser scattering particle size analyzer (MICROTRACK, manufactured by Nikkiso Co., Ltd.). A particle diameter providing 50% accumulation is defined as the volume-average particle diameter D50ᵥ. In the volume-average particle size distribution index GSDv, the ratio of particles having a particle diameter of 45 μm or more is determined from the channels.

The true specific gravity of the carrier (core material in the case of a coated carrier) is, for example, preferably 2.5 g/cm³ or more and 6.0 g/cm³ or less, more preferably 2.8 g/cm³ or more and 5.5 g/cm³ or less, and still more preferably 3.0 g/cm³ or more and 5.0 g/cm³ or less.

The true specific gravity of the carrier is a value determined as follows.

For example, in the case of a coated carrier, the true specific gravity ρ of the carrier is adjusted by the type of magnetic powder used. In the case of a magnetic powder-dispersed carrier, the true specific gravity ρ of the carrier is adjusted by the type of magnetic powder used, the amount of magnetic powder filled etc.

The true specific gravity of the carrier is measured, for example, in accordance with a gas-phase substitution method using a high-precision and automatic volumeter (for example, VM-100 manufactured by ESTEC).

Specific examples of the carrier include coated carriers in which the surface of a core material formed of a magnetic powder is coated with a coating resin, magnetic powder-dispersed carriers in which a magnetic powder is dispersed and mixed in a matrix resin, and resin-impregnated carriers in which a porous magnetic powder is impregnated with a resin.

The magnetic powder-dispersed carriers may be carriers composed of particles in which a magnetic powder is dispersed and mixed in a matrix resin, the particles functioning as a core material and being coated with a coating resin. Similarly, the resin-impregnated carriers may be carriers composed of particles in which a porous magnetic powder is impregnated with a resin, the particles functioning as a core material and being coated with a coating resin.

Examples of the magnetic powder include magnetic metals such as iron, nickel, and cobalt, and magnetic oxides such as ferrite and magnetite.

Examples of the coating resin that coats a core material and the matrix resin in which a magnetic powder is dispersed and mixed include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylic acid copolymers, straight silicone resins having organosiloxane bonds and modified resins thereof, fluorocarbon resins, polyesters, polycarbonates, phenolic resins, and epoxy resins.

The coating resin that coats a core material and the matrix resin in which a magnetic powder is dispersed and mixed may contain other additives such as an electrically conductive material.

In order to coat the surface of the core material of the carrier with a coating resin, for example, the core material may be coated with a solution for forming a coating layer, the solution being prepared by dissolving the coating resin and optional additives in an appropriate solvent. The solvent is not particularly limited, and may be selected in view of the coating resin used, application suitability, and the like.

Specific examples of the resin coating method include a dipping method in which a core material is dipped in a solution for forming a coating layer, a spray method in which a solution for forming a coating layer is sprayed onto the surface of a core material, a fluidized bed method in which a solution for forming a coating layer is sprayed while floating a core material with flowing air, and a kneader coater method in which a core material of the carrier and a solution for forming a coating layer are mixed in a kneader coater, and the solvent is then removed.

Herein, the amount of coating of the coating resin to the core material is, for example, preferably 0.5% by mass or more (more preferably 0.7% by mass or more and 6% by mass or less, and still more preferably 1.0% by mass or more and 5.0% by mass or less) of the total mass of the carrier.

If the core material is excessively exposed, and when a magnetic brush contacts a photoreceptor (image-carrying member) during development, a hard core material of the carrier constituting the magnetic brush contacts the surface of the photoreceptor (image-carrying member). Consequently, a strong scraping force is generated. Thus, a fluorocarbon resin applied onto the surface of the photoreceptor (image-carrying member) may be adversely easily removed, and fog may be generated.

In addition, if the exposed core material contacts the photoreceptor (image-carrying member), charge leakage may easily occur.

For this reason, the amount of coating of the coating resin to the core material is preferably adjusted to be the above range.

This amount of coating is determined as follows.

In the case of a coating resin that is soluble in a solvent, a carrier that has been accurately weighed is dissolved in a soluble solvent (e.g., toluene), the magnetic powder is held with a magnet, and the solution in which the coating resin is dissolved is drained away. By repeating this operation several times, the magnetic powder from which the coating resin has been removed remains. The magnetic powder is dried, and the mass of the magnetic powder is then measured. The amount of coating is calculated by dividing the difference by the amount of carrier.

More specifically, 20.0 g of a carrier is weighed and placed in a beaker, 100 g of toluene is then added to the beaker, and the resulting mixture is stirred with a blade for 10 minutes. A magnet is placed under the bottom of the beaker, and the toluene is drained away in such a way that the core material (magnetic powder) does not flow out. This operation is repeated four times, and the beaker after the toluene is drained away is dried. After the drying, the amount of magnetic powder is measured. The amount of coating is calculated by using a formula [(the amount of carrie—the amount of magnetic powder after washing)/the amount of carrier].

On the other hand, in the case of a coating resin that is insoluble in a solvent, a carrier is heated in a nitrogen. atmosphere in the range of room temperature (25° C.) or higher and 1,000° C. or lower with a Thermo plus EVO II differential thermogravimetric analyzer TG 8120 manufactured by Rigaku Corporation. The amount of coating is calculated from the decrease in the mass of the carrier.

In the developer, the mixing ratio (mass ratio) of the toner and the carrier is, for example, approximately in the range of toner:carrier=1:100 to 30:100.

### Electrophotographic Photoreceptor

Examples of the electrophotographic photoreceptor 10 include (1) a photoreceptor including a conductive base, an undercoat layer formed on the conductive base, and a charge generation layer, a charge transport layer, and a protective layer that are sequentially formed on the undercoat layer in that order, (2) a photoreceptor including a conductive base, an undercoat layer formed on the conductive base, and a charge transport layer, a charge generation layer, and a protective layer that are sequentially formed on the undercoat layer in that order, and (3) a photoreceptor including a conductive base, an undercoat layer formed on the conductive base, and a single-layer photosensitive layer and a protective layer that are sequentially formed on the undercoat layer in that order.

The charge generation layer and the charge transport layer are function-separated photosensitive layers. In the electrophotographic photoreceptor 10, the undercoat layer may be formed or may not be formed.

As the protective layer constituting the top surface layer of the electrophotographic photoreceptor 10, for example, a protective layer composed of a cured film containing fluorocarbon resin particles is used. Each of the above layers will be described in detail below.

First, the conductive base will be described.

Any conductive base that has been usually used may be used as the conductive base. Examples of the conductive base include metals such as aluminum, nickel, chromium, and stainless steel; plastic films or the like having a thin film (e.g., a thin film made of aluminum, titanium, nickel, chromium, stainless steel, gold, vanadium, tin oxide, indium oxide, or indium tin oxide (ITO)) thereon; paper onto which a conductivity-imparting agent is applied or which is impregnated with a conductivity-imparting agent; and plastic films onto which a conductivity-imparting agent is applied or which is impregnated with a conductivity-imparting agent. The shape of the base is not limited to a cylindrical shape, and may be a sheet-like shape or a plate-like shape.

Conductive base particles preferably have a conductivity corresponding to, for example, a volume resistivity of less than 10⁷ Ω·cm.

When a metal pipe is used as the conductive base, the surface of the pipe may be that of the original pipe. Alternatively, a treatment such as mirror surface cutting, etching, anodic oxidation, rough cutting, centerless grinding, sandblasting, or wet honing may be conducted on the surface in advance.

Next, the undercoat layer will be described.

The undercoat layer is provided as required in order to prevent light reflection on the surface of the conductive base and to prevent an unnecessary carrier from flowing from the conductive base to a photosensitive layer.

The undercoat layer contains a binder resin and optional other additives.

Examples of the binder resin contained in the undercoat layer include known polymer compounds such as acetal resins e.g., polyvinyl butyral, polyvinyl alcohol resins, casein, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenolic resins, phenol-formaldehyde resins, melamine resins, and urethane resins; charge transporting resins having a charge transporting group; and conductive resins such as polyaniline. Among these resins, resins that are insoluble in a solvent of a composition for forming the upper layer are preferably used. For example, phenolic resins, phenol-formaldehyde resins, melamine resins, urethane resins, and epoxy resins are particularly preferably used.

The undercoat layer may contain a metallic compound such as a silicon compound, an organozirconium compound, an organotitanium compound, or an organoaluminum compound.

The ratio of the metallic compound to the binder resin is not particularly limited as long as desired electrophotographic photoreceptor characteristics are achieved.

Resin particles may be incorporated into the undercoat layer for the purpose of adjusting the surface roughness. Examples of the resin particles include silicone resin particles and cross-linked polymethyl methacrylate (PMMA) resin particles. In order to adjust the surface roughness, after the formation of the undercoat layer, the surface of the undercoat layer may be polished. Examples of the polishing method include buffing, sandblasting, wet honing, and grinding.

The undercoat layer contains at least the binder resin and conductive particles, for example. The conductive particles preferably have a conductivity corresponding to, for example, a volume resistivity of less than 10⁷ Ω·cm.

Examples of the conductive particles include metal particles (particles made of aluminum, copper, nickel, silver, or the like), conductive metal oxide particles (particles made of antimony oxide, indium oxide, tin oxide, zinc oxide, and the like), conductive substance particles (particles of carbon fibers, carbon black, and a graphite powder). Among these conductive particles, conductive metal oxide particles are preferable. These conductive particles may be used in combination of two or more types of particles.

The conductive particles may be subjected to a surface treatment with a hydrophobizing agent (e.g., a coupling agent), or the like so as to adjust the resistance.

The content of the conductive particles is, for example, preferably 10% by mass or more and 80% by mass or less, and more preferably 40% by mass or more and 80% by mass or less based on the binder resin.

In forming the undercoat layer, a coating liquid for forming the undercoat layer is prepared by adding the above components to a solvent and used.

In preparation of the coating liquid for forming the undercoat layer, the particles may be dispersed by a method using a media dispersion device such as a ball mill, a vibration ball mill, an attritor, a sand mill, or a horizontal-type sand mill, or a medialess dispersion device such as a stirrer, an ultrasonic dispersion device, a roll mill, and a high-pressure homogenizer. Examples of the high-pressure homogenizer include a homogenizer that uses a collision method in which dispersion is performed by subjecting a dispersion liquid to liquid-liquid collision or liquid-wall collision at a high pressure and a homogenizer that uses a flow-through method in which dispersion is performed by causing a dispersion liquid to pass through a fine flow channel at a high pressure.

Examples of a method for applying the coating liquid for forming the undercoat layer onto the conductive base include dip coating, ring dip coating, wire-bar coating, spray coating, blade coating, knife coating, and curtain coating.

The thickness of the undercoat layer is preferably 15 μm or more, and more preferably 20 μm or more and 50 μm or less.

Although not illustrated in the figure, an intermediate layer may be further provided between the undercoat layer and the photosensitive layer. Examples of a binder resin used in the intermediate layer include polymer compounds such as acetal resins e.g., polyvinyl butyral, polyvinyl alcohol resins, casein, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins; and organometallic compounds containing, for example, an atom of zirconium, titanium, aluminum, manganese, or silicon. These compounds may be used alone or as a mixture or polycondensate of two or more compounds. In particular, organometallic compounds containing zirconium or silicon are preferable from the standpoint that, for example, the residual potential is low, a change in the potential due to the environment is small, and a change in the potential caused by repeated use is small.

In forming the intermediate layer, a coating liquid for forming the intermediate layer is prepared by adding the above component to a solvent and used.

Examples of a coating method for forming the intermediate layer include usual methods such as dip coating, ring dip coating, wire-bar coating, spray coating, blade coating, knife coating, and curtain coating.

The intermediate layer has a function of improving coatability of the upper layer, and also functions as an electrically blocking layer. However, when the thickness of the intermediate layer is excessively large, the electric barrier becomes excessively strong, which may cause desensitization and an increase in the potential due to repetition. Accordingly, in the case where the intermediate layer is formed, the thickness of the intermediate layer is preferably adjusted to be in the range of 0.1 μm or more and 3 μm or less. The intermediate layer in this case may be used as the undercoat layer.

Next, the charge generation layer will be described.

The charge generation layer contains a charge-generating material and a binder resin. Examples of the charge-generating material include phthalocyanine pigments such as metal-free phthalocyanine, chlorogallium phthalocyanine, hydroxygallium phthalocyanine, dichlorotin phthalocyanine, and titanyl phthalocyanine. In particular, examples thereof include a chlorogallium phthalocyanine crystal having strong diffraction peaks at Bragg angles (2θ±0.2°) of at least 7.4°, 16.6°, 25.5°, and 28.3° in an X-ray diffraction spectrum obtained by using CuKα characteristic X-rays; a metal-free phthalocyanine crystal having strong diffraction peaks at Bragg angles (2θ±0.2°) of at least 7.7°, 9.3°, 16.9°, 17.5°, 22.4°, and 28.8° in an X-ray diffraction spectrum obtained by using CuKa characteristic X-rays; a hydroxygallium phthalocyanine crystal having strong diffraction peaks at Bragg angles (2θ±0.2°) of at least 7.5°, 9.9°, 12.5°, 16.3°, 18.6°, 25.1°, and 28.3° in an X-ray diffraction spectrum obtained by using CuKa characteristic X-rays; and a titanyl phthalocyanine crystal having strong diffraction peaks at Bragg angles (2θ±0.2°) of at least 9.6°, 24.1°, and 27.2° in an X-ray diffraction spectrum obtained by using CuKα characteristic X-rays. Examples of the charge-generating material further include quinone pigments, perylene pigments, indigo pigments, bisbenzimidazole pigments, anthrone pigments, and quinacridone pigments. These charge-generating materials may be used alone or in combination of two or more materials.

Examples of the binder resin contained in the charge generating layer include polycarbonate resins such as bisphenol A polycarbonate resins and bisphenol Z polycarbonate resins, acrylic resins, methacrylic resins, polyarylate resins, polyester resins, polyvinyl chloride resins, polystyrene resins, acrylonitrile-styrene copolymers, acrylonitrile-butadiene copolymers, polyvinyl acetate resins, polyvinyl formal resins, polysulfone resins, styrene-butadiene copolymers, vinylidene chloride-acrylonitrile copolymers, vinyl chloride-vinyl acetate-maleic anhydride resins, silicone resins, phenol-formaldehyde resins, polyacrylamide resins, polyamide resins, and poly-N-vinylcarbazole resins. These binder resins may be used alone or in combination of two or more resins.

The mixing ratio of the charge-generating material to the binder resin is preferably in the range of, for example, 10:1 to 1:10.

In forming the charge generation layer, a coating liquid for forming the charge generation layer is prepared by adding the above components to a solvent and used.

In preparation of the coating liquid for forming the charge generation layer, particles (e.g., charge-generating material) may be dispersed by a method using a media dispersion device such as a ball mill, a vibration ball mill, an attritor, a sand mill, or a horizontal-type sand mill, or a medialess dispersion device such as a stirrer, an ultrasonic dispersion device, a roll mill, and a high-pressure homogenizer. Examples of the high-pressure homogenizer include a homogenizer that uses a collision method in which dispersion is performed by subjecting a dispersion liquid to liquid-liquid collision or liquid-wall collision at a high pressure and a homogenizer that uses a flow-through method in which dispersion is performed by causing a dispersion liquid to pass through a fine flow channel at a high pressure.

Examples of a method for applying the coating liquid for forming the charge generation layer onto the undercoat layer include dip coating, ring dip coating, wire-bar coating, spray coating, blade coating, knife coating, and curtain coating.

The thickness of the charge generation layer is preferably 0.01 μm or more and 5 μm or less, and more preferably 0.05 μm or more and 2.0 μm or less.

Next, the charge transport layer will be described. The charge transport layer contains a charge-transporting material and, as required, a binder resin. When the charge transport layer functions as the top surface layer, the charge transport layer contains fluorocarbon resin particles.

Examples of the charge-transporting material include hole-transporting materials such as oxadiazole derivatives, e.g., 2,5-bis(p-diethylaminophenyl)-1,3,4-oxadiazole, pyrazoline derivatives, e.g., 1,3,5-triphenyl-pyrazoline and 1-[pyridyl-(2)]-3-(p-diethylaminostyryl)-5-(p-diethylaminostyryl)pyrazoline, aromatic tertiary amino compounds, e.g., triphenylamine, N,N′-bis(3,4-dimethylphenyl)biphenyl-4-amine, tri(p-methylphenyl)aminyl-4-amine, and dibenzylaniline, aromatic tertiary diaminocompounds, e.g., N,N′-bis(3-methylphenyl)-N,N′-diphenylbenzidine, 1,2,4-triazine derivatives, e.g., 3-(4′-dimethylaminophenyl)-5,6-di(4′-methoxyphenyl)-1,2,4-triazine, hydrazone derivatives, e.g., 4-diethylaminobenzaldehyde-1,1-diphenylhydrazone, quinazoline derivatives, e.g., 2-phenyl-4-styryl-quinazoline, benzofuran derivatives, e.g., 6-hydroxy-2,3-di(p-methoxyphenyl)benzofuran, α-stilbene derivatives, e.g., p-(2,2-diphenylvinyl)-N,N′-diphenylaniline, enamine derivatives, carbazole derivatives, e.g., N-ethylcarbazole, and poly-N-vinylcarbazole and derivatives thereof; electron-transporting materials such as quinone compounds, e.g., chloranil and bromoanthraquinone, tetracyanoquinodimethane compounds, fluorenone compounds, e.g., 2,4,7-trinitrofluorenone and 2,4,5,7-tetranitro-9-fluorenone, xanthone compounds, and thiophene compounds. Examples of the charge-transporting material further include polymers having a group containing any of the compounds described above in the main chain or a side chain thereof. These charge-transporting materials may be used alone or in combination of two or more materials.

Examples of the binder resin contained in the charge transport layer include insulating resins such as polycarbonate resins, e.g., bisphenol A polycarbonate resins and bisphenol Z polycarbonate resins, acrylic resins, methacrylic resins, polyarylate resins, polyester resins, polyvinyl chloride resins, polystyrene resins, acrylonitrile-styrene copolymers, acrylonitrile-butadiene copolymers, polyvinyl acetate resins, polyvinyl formal resins, polysulfone resins, styrene-butadiene copolymers, vinylidene chloride-acrylonitrile copolymers, vinyl chloride-vinyl acetate-maleic anhydride resins, silicone resins, phenol-formaldehyde resins, polyacrylamide resins, polyamide resins, and chlorine rubber; and organic photoconductive polymers such as polyvinyl carbazole, polyvinyl anthracene, and polyvinyl pyrene. These binder resins may be used alone or in combination of two or more resins.

The mixing ratio of the charge-transporting material to the binder resin is preferably in the range of, for example, 10:1 to 1:5.

The charge transport layer is formed using a coating liquid for forming the charge transport layer, the coating liquid being prepared by adding the above components to a solvent.

In preparation of the coating liquid for forming the charge transport layer, particles (e.g., fluorocarbon resin particles) may be dispersed by a method using a media dispersion device such as a ball mill, a vibration ball mill, an attritor, a sand mill, or a horizontal-type sand mill, or a medialess dispersion device such as a stirrer, an ultrasonic dispersion device, a roll mill, and a high-pressure homogenizer. Examples of the high-pressure homogenizer include a homogenizer that uses a collision method in which dispersion is performed by subjecting a dispersion liquid to liquid-liquid collision or liquid-wall collision at a high pressure and a homogenizer that uses a flow-through method in which dispersion is performed by causing a dispersion liquid to pass through a fine flow channel at a high pressure.

Examples of a method for applying the coating liquid for forming the charge transport layer onto the'charge generation layer include usual methods such as dip coating, ring dip coating, wire-bar coating, spray coating, blade coating, knife coating, and curtain coating.

The thickness of the charge transport layer is preferably adjusted to be 5 μm or more and 50 μm or less, and more preferably 10 μm'or more and 40 μm or less.

Next, the single-layer photosensitive layer will be described.

In the single-layer photosensitive layer (charge generation/charge transport layer), the content of the charge-generating material is preferably 10% by mass or more and 85% by mass or less (more preferably 20% by mass or more and 50% by mass or less), and the content of the charge-transporting material is preferably 5% by mass or more and 50% by mass or less.

The method for forming the single-layer photosensitive layer (charge generation/charge transport layer) is the same as the method for forming the charge generation layer or the charge transport layer.

The thickness of the single-layer photosensitive layer (charge generation/charge transport layer) is, for example, preferably about 5 μm or more and about 50 μm or less, and more preferably about 10 μm or more and about 40 μm or less.

Next, the protective layer will be described.

The protective layer is composed of a cured film containing fluorocarbon resin particles.

Specifically, for example, the protective layer may be a cured film composed of a curable resin composition containing fluorocarbon resin particles, a curable resin, and a charge-transporting material.

Curable resins are crosslinkable resins that are polymerized by heating or light irradiation to form a polymer network structure, and thus that are cured and do not return to the original state. In particular, thermosetting resins are preferably used as the curable resins.

Examples of the thermosetting resins include, but are not limited to, melamine resins, phenolic resins, urea resins, benzoguanamine resins, epoxy resins, unsaturated polyester resins, alkyd resins, polyurethanes, polyimide resins, and curable acrylic resins. These thermosetting resins may be used alone or in combination of two or more thermosetting resins.

The charge-transporting material is not particularly limited. However, the charge-transporting material is preferably a compound that is compatible with the curable resin, and more preferably a compound that forms a chemical bond with the curable resin used. Examples of the charge transporting organic compound having a reactive functional group that forms a chemical bond with the curable resin include compounds having at least one substituent selected from —OH, —OCH₃, —NH₂, —SH, and —COOH.

The protective layer may be a cured film composed of a curable composition containing fluorocarbon resin particles, at least one compound selected from guanamine compounds and melamine compounds, and a charge-transporting material having at least one substituent selected from —OH, —OCH₃, —NH₂, —SH, and —COOH (hereinafter simply referred to as “specific charge-transporting material”).

As for the curable resin, in addition to at least one compound selected from guanamine compounds and melamine compounds, for example, other curable resins (such as phenolic resins, melamine resins, urea resins, alkyd resins, and benzoguanamine resins) and spiroacetal guanamine resins (such as CTU-GUANAMINE manufactured by Ajinomoto Fine-Techno Co., Inc.) may be used in combination.

Herein, in the curable composition for forming a cured film functioning as the protective layer, the total content of the guanamine compounds and the melamine compounds relative to the total solid content except for the fluorocarbon resin particles (including a fluorinated alkyl group-containing copolymer that functions as a dispersant of the fluorocarbon resin particles) is preferably 0.1% by mass or more and 20% by mass or less, and the content of the specific charge-transporting material relative to the total solid content except for the fluorocarbon resin particles (including a fluorinated alkyl group-containing copolymer that functions as a dispersant of the fluorocarbon resin particles) is preferably 80% by mass or more and 99.9% by mass or less.

The guanamine compounds will be described.

The guanamine compounds are compounds having a guanamine skeleton (structure), and may be monomers or multimers. Herein, the term “multimer” refers to an oligomer obtained by polymerizing a monomer as a structural unit, and the degree of polymerization of the multimer is, for example, 2 or more and 200 or less (and preferably 2 or more and 100 or less).

Examples of the guanamine compounds include acetoguanamine, benzoguanamine, formoguanamine, steroguanamine, spiroguanamine, and cyclohexylguanamine.

Examples of commercially available guanamine compounds include SUPER BECKAMINE (R) L-148-55, SUPER BECKAMINE (R) 13-535, SUPER BECKAMINE (R) L-145-60, and SUPER BECKAMINE (R) TD-126, all of which are manufactured by DIC Corporation; and NIKALAC BL-60 and NIKALAC BX-4000, which are manufactured by Nippon Carbide Industries Co., Inc.

After the synthesis of the guanamine compounds (including multimers) or after the purchase of the commercially available guanamine compounds (including multimers), in order to eliminate the influence of a remaining catalyst, the guanamine compounds (including multimers) may be dissolved in an appropriate solvent such as toluene, xylene, or ethyl acetate, and may be washed with distilled water, ion-exchange water, or the like. Alternatively, the remaining catalyst may be removed by treating with an ion-exchange resin.

The guanamine compounds may be used alone or in combination of two or more compounds.

The melamine compounds will be described.

The melamine compounds are compounds having a melamine skeleton (structure), and may be monomers or multimers. Herein, the term “multimer” refers to an oligomer obtained by polymerizing a monomer as a structural unit, and the degree of polymerization of the multimer is, for example, 2 or more and 200 or less (and preferably 2 or more and 100 or less).

Examples of commercially available melamine compounds include SUPER MELAMI No. 90 manufactured by NOF Corporation, SUPER BECKAMINE (R) TD-139-60 manufactured by DIC Corporation, U-VAN 2020 manufactured by Mitsui Chemicals, Inc.), SUMITEX RESIN M-3 manufactured by Sumitomo Chemical Co., Ltd. and NIKALAC MW-30 manufactured by Nippon Carbide Industries Co., Inc.

After the synthesis of the melamine compounds (including multimers) or after the purchase of the commercially available melamine compounds (including multimers), in order to eliminate the influence of a remaining catalyst, the melamine compounds (including multimers) may be dissolved in an appropriate solvent such as toluene, xylene, or ethyl acetate, and may be washed with distilled water, ion-exchange water, or the like. Alternatively, the remaining catalyst may be removed by treating with an ion-exchange resin.

The melamine compounds may be used alone or in combination of two or more compounds.

The specific charge-transporting material will be described.

Examples of the specific charge-transporting material preferably include compounds having at least one substituent (hereinafter, may be simply referred to as “specific reactive functional group”) selected from —OH, —OCH₃, —NH₂, —SH, and —COOH. In particular, the specific charge-transporting material is preferably a compound having at least two of the above specific reactive functional groups and more preferably a compound having three of the above specific reactive functional groups.

The specific charge-transporting material may be a compound represented by general formula (I) below.

F—((—R¹—X)ₙ₁(R²)ₙ₃—Y)ₙ₂ (I)

In general formula (I), F represents an organic group derived from a compound having a hole-transporting capability, R¹ and R² each independently represent a linear or branched alkylene group having 1 to 5 carbon atoms, n1 represents 0 or 1, n2 represents an integer of 1 to 4, and n3 represents 0 or 1, X represents an oxygen atom, NH, or a sulfur atom, and Y represents —OH, —OCH₃, —NH₂, —SH, or —COOH (i.e., the above specific reactive functional group).

In general formula (I), the compound having a hole-transporting capability from which the organic group represented by F is derived is preferably an arylamine derivative. Examples of the arylamine derivative include triphenylamine derivatives and tetraphenylbenzidine derivatives.

The compound represented by general formula (I) is preferably a compound represented by general formula (II) below.

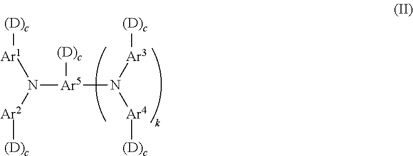

In general formula (II), Ar¹ to Ar⁴ may be the same or different, and each independently represent a substituted or unsubstituted aryl group, Ar⁵ represents a substituted or unsubstituted aryl group or a substituted or unsubstituted arylene group, each D independently represents —(—R¹—X)ₙ₁(R²)ₙ₃—Y (wherein R¹ and R² each independently represent a linear or branched alkylene group having 1 to 5 carbon atoms, nl represents 0 or 1, n3 represents 0 or 1, X represents an oxygen atom, NH, or a sulfur atom, and Y represents —OH, —OCH₃, —NH₂, —SH, or —COOH), each c independently represents 0 or 1, k represents 0 or 1, and the total number of D is 1 to 4.

In general formula (II), “—(—R¹—X)ₙ₁(R²)ₙ₃—Y” represented by D has the same definitions as in general formula (I), and R¹ and R² each independently represents a linear or branched alkylene group having 1 to 5 carbon atoms. Furthermore, n1 is preferably 1, X is preferably an oxygen atom, and Y is preferably a hydroxyl group.

In general formula (II), the total number of D corresponds to n2 in general formula (I), and is preferably 2 or more and 4 or less, and more preferably 3 or more and 4 or less. Specifically, the compounds represented by general formulae (I) and (II) preferably have 2 or more and 4 or less of the specific reactive functional groups per molecule, and more preferably 3 or more and 4 or less of the specific reactive functional groups per molecule.

In general formula (II), each of Ar¹ to Ar⁴ is preferably any one of the groups represented by formulae (1) to (7) below. Note that formulae (1) to (7) are shown together with “-(D)_{c}”, which may be bonded to each of Ar¹ to Ar⁴.

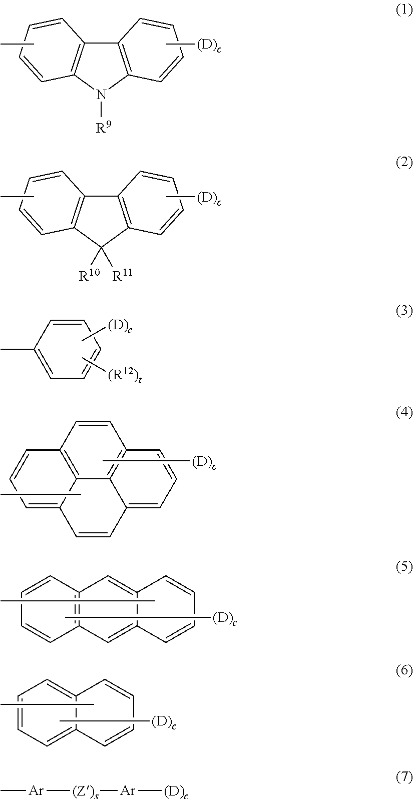

In formulae (1) and (7), R⁹ represents one selected from a hydrogen atom, an alkyl group having 1 to 4 carbon atoms, a phenyl group substituted by an alkyl group having 1 to 4 carbon atoms or by an alkoxy group having 1 to 4 carbon atoms, an unsubstituted phenyl group, and an aralkyl group having 7 to 10 carbon atoms; R¹⁰ to ^{R}¹² each independently represent one selected from a hydrogen atom, an alkyl group. having 1 to 4 carbon atoms, an alkoxy group having 1 to 4 carbon atoms, a phenyl group substituted by an alkoxy group having 1 to 4 carbon atoms, an unsubstituted phenyl group, an aralkyl group having 7 to 10 carbon atoms,.and a halogen atom; Ar represents a substituted or unsubstituted arylene group; D and c are defined in the same manner as “D” and “c” in general formula (II); s represents 0 or 1; and t represents an integer of 1 to 3.

In formula (7), each of Ar is preferably a group represented by formula (8) or (9) below.

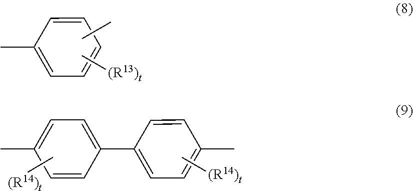

In formulae (8) and (9), R¹³ and R¹⁴s each independently represent one selected from a hydrogen atom, an alkyl group having 1 to 4 carbon atoms, an alkoxy group having 1 to 4 carbon atoms, a phenyl group substituted by an alkoxy group having 1 to 4 carbon atoms, an unsubstituted phenyl group, an aralkyl group having 7 to 10 carbon atoms, and a halogen atom; and each t independently represents an integer of 1 to 3.

In formula (7), Z′ is preferably a group represented by any one of formulae (10) to (17) below.

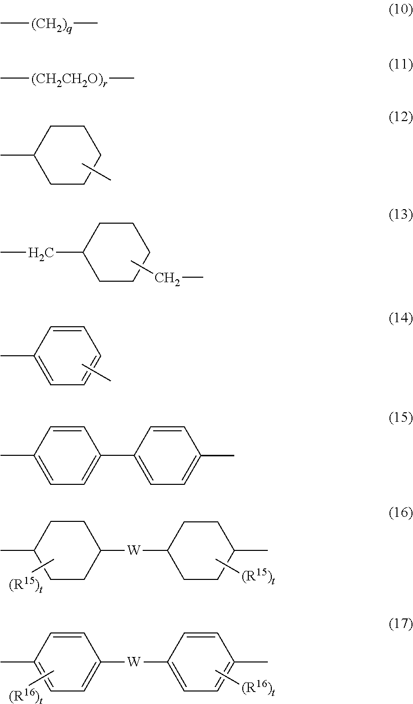

In formulae (10) to (17), R¹⁵s and R¹⁶s each independently represent one selected from a hydrogen atom, an alkyl group having 1 to 4 carbon atoms, a phenyl group substituted by an alkyl group having 1 to 4 carbon atom or by an alkoxy group having 1 to 4 carbon atoms, an unsubstituted phenyl group, an aralkyl group having 7 to 10 carbon atoms, and a halogen atom; W represents a divalent group; q and r each independently represent an integer of 1 to 10; and each t independently represents an integer of 1 to 3.

In formulae (16) and (17), W is preferably any one of the divalent groups represented by formulae (18) to (26) below. In formula (25), u represents an integer of 0 to 3.

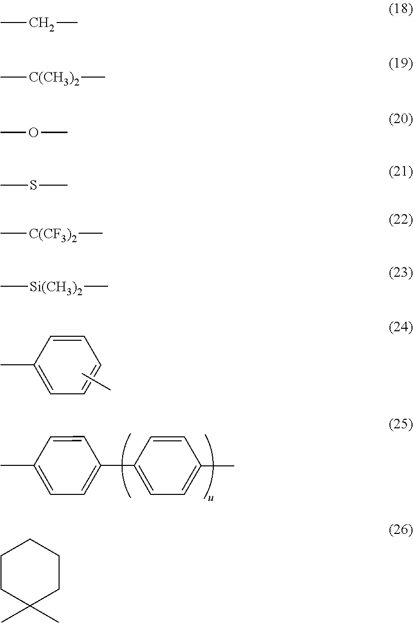

In general formula (II), when k is 0, Ar⁵ is preferably an aryl group represented by any one of formulae (1) to (7) exemplified in the description of Ar¹ to Ar⁴. In general formula (II), when k is 1, Ar⁵ is preferably an arylene group obtained by removing one hydrogen atom from an aryl group represented by any one of formulae (1) to (7) above.

Fluorocarbon resin particles will now be described.

The fluorocarbon resin particles are not particularly limited. For example, among polytetrafluoroethylene (PTFE), polychlorotrifluoroethylene, polyhexafluoropropylene, polyvinyl fluoride, polyvinylidene fluoride, polydichlorodifluoroethylene, and copolymers thereof, at least one of these resins is preferably selected. Polytetrafluoroethylene and polyvinylidene fluoride are more preferable, and polytetrafluoroethylene is particularly preferable.

The fluorocarbon resin particles preferably have an average primary particle diameter of 0.05 μm or more and 1 μm or less, and more preferably 0.1 μm or more and 0.5 μm or less.

The term “average primary particle diameter of the fluorocarbon resin particles” refers to a value determined by performing measurement of a measurement solution, which is prepared by diluting a dispersion liquid of the fluorocarbon resin particles with the same solvent as the dispersion liquid, using a laser diffraction particle size distribution analyzer LA-920 (manufactured by HORIBA, Ltd.) at a refractive index of 1.35.

The content of the fluorocarbon resin particles (the content relative to the total solid content of the protective layer) is, for example, preferably 1% by mass or more and 30% by mass or less, and more preferably 2% by mass or more and 20% by mass or less.

When the content of the fluorocarbon resin particles is increased, the generation of streak-like fog is suppressed. However, light scattering tends to occur in the layer, reproducibility of lines and characters decreases, and granularity also decreases. For this reason, the content of the fluorocarbon resin particles is preferably in the above range.

In order to improve dispersibility of the fluorocarbon resin particles, a fluorine-containing dispersant may be used in combination. An example of the fluorine-containing dispersant is a fluorinated alkyl group-containing copolymer.

The fluorinated alkyl group-containing copolymer is not particularly limited, but preferably a fluorine-containing graft polymer having repeating units represented by structural formulae (1) and (2) below. The fluorinated alkyl group-containing copolymer is preferably a resin synthesized by, for example, graft-polymerizing a macromonomer composed of an acrylic acid ester, a methacrylic acid ester, or the like and a perfluoroalkylethyl (meth)acrylate or a perfluoroalkyl (meth)acrylate. Herein, the term “(meth)acrylate” refers to acrylate or methacrylate.

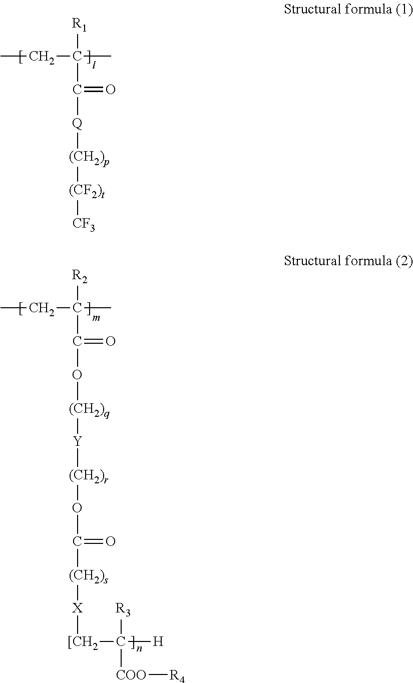

In structural formulae (1) and (2), l, m, and n each independently represent an integer of 1 or more; p, q, r, and s each independently represent an integer of 0 or 1; t represents an integer of 1 to 7; R₁, R₂, R₃, and R₄ each independently represent a hydrogen atom or an alkyl group; X represents an alkylene chain, a halogen-substituted alkylene chain, —S—, —O—, —NH—, or a single bond; Y represents an alkylene chain, a halogen-substituted alkylene chain, —(C_{z}H_{2z—1} (OH))— (wherein z represents an integer of 1 or more), or a single bond; and Q represents —O— or —NH—.

The fluorinated alkyl group-containing copolymer preferably has a weight-average molecular weight of 10,000 or more and 100,000 or less, and more preferably 30,000 or more and 100,000 or less.

In the fluorinated alkyl group-containing copolymer, a content ratio of structural formula (1) to structural formula (2), i.e., 1:m is preferably 1:9 to 9:1, and more preferably 3:7 to 7:3.

In structural formulae (1) and (2), examples of the alkyl group represented by R₁, R₂, R₃, and R₄ include a methyl group, an ethyl group, and a propyl group. R₁, R₂, R₃, and R₄ are each preferably a hydrogen atom or a methyl group. Among these, a methyl group is more preferable.

The fluorinated alkyl group-containing copolymer may further contain a repeating unit represented by structural formula (3). As for the content of structural formula (3), a ratio ((1+m):z) of the sum of the content of structural formula (1) and the content of structural formula (2) (1+m) to the content of structural formula (3) (z) is preferably (1+m):z=10:0 to 7:3, and more preferably 9:1 to 7:3.

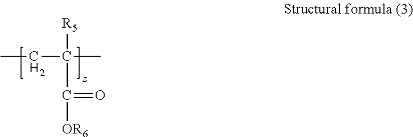

In structural formula (3), R₅ and R₆ each independently represent a hydrogen atom or an alkyl group, and z represents an integer of 1 or more.

R₅ and R₆ are each preferably a hydrogen atom, a methyl group, or an ethyl group. Among these, a methyl group is more preferable.

The content of the fluorinated alkyl group-containing copolymer is preferably 1% by mass or more and 10% by mass or less relative to the mass of the fluorocarbon resin particles.

Other additives will be described.

The protective layer may contain a surfactant, an antioxidant, a curing catalyst, and other additives.

The thickness of the protective layer is preferably adjusted to be 1 μm or more and 25 μm or less, and more preferably 2 μm or more and 10 μm or less.

As the electrophotographic photoreceptor 10, an exemplary embodiment has been described in which the protective layer functioning as the top surface layer is a cured film containing fluorocarbon resin particles. However, the structure of the electrophotographic photoreceptor 10 is not limited thereto. For example, when the protective layer is not provided and the charge transport layer or the single-layer photosensitive layer functions as the top surface layer, the charge transport layer or the single-layer photosensitive layer may be a cured film containing fluorocarbon resin particles.

### Charging Device

Examples of the charging device 20 include contact-type charging devices using a conductive charging roller, charging brush, charging film, charging rubber blade, charging tube, or the like. Examples of the charging device 20 further include a non-contact-type roller charging device, and known charging devices, such as a scorotron charging device and a corotron charging device that utilize corona discharge. The charging device 20 is preferably a contact-type charging device.

In this exemplary embodiment, discharge products are easily produced when a charging device that applies a voltage obtained by superimposing an AC voltage on a DC voltage is used. However, even when such a charging device is used, adhesion and deposition of the discharge products on the electrophotographic photoreceptor 10 are suppressed, thereby suppressing print defects in terms of image density.

### Exposure Device

An example of the exposure device 30 is an optical unit that irradiates the surface of the electrophotographic photoreceptor 10 with light such as a semiconductor laser beam, an LED beam, or light through a liquid crystal shutter, in the form of a desired image. The wavelength of the light source may be within a range corresponding to the spectral sensitivity range of the electrophotographic photoreceptor 10. The wavelength of the semiconductor laser may be within a near-infrared range having an oscillation wavelength at around 780 nm. However, the oscillation wavelength of the semiconductor laser is not limited to this range. Lasers having an oscillation wavelength on the order of 600 nm and blue lasers having an oscillation wavelength of 400 nm or more and 450 nm or less may also be used. Furthermore, for example, in order to form a color image, a surface-emitting laser light source capable of multibeam output is also useful as the exposure device 30.

### Developing Device

The developing device 40 is arranged so as to face the electrophotographic photoreceptor 10 in a development region. The developing device 40 includes, for example, a developer container 41 (developing device body) that contains a developer (two-component developer) containing a toner and a carrier, and a supplemental developer container (toner cartridge) 47. The ,developer container 41 includes a developer container body 41A and a developer container cover 41B that covers the top of the developer container body 41A.

For example, the developer container body 41A has, inside thereof, a developing roller chamber 42A for installing a developing roller (an example of a developer-carrying member) 42, a first stirring chamber 43A, and a second stirring chamber 44A adjacent to the first stirring chamber 43A, the first and second stirring chambers 43A and 44A being adjacent to the developing roller chamber 42A. For example, a layer-thickness control member 45 is provided in the developing roller chamber 42A. The layer-thickness control member 45 controls a layer thickness of the developer on the surface of the developing roller 42 when the developer container cover 41B is fitted on the developer container body 41A.

The first stirring chamber 43A and the second stirring chamber 44A are separated by, for example, a partition wall 41C. Although not shown in the figure, openings are provided on both ends in a longitudinal direction of the partition wall 41C (i.e., longitudinal direction of the developing device) so that the first stirring chamber 43A and the second stirring chamber 44A communicate with each other. Thus, a circulation stirring chamber (43A+44A) is formed by the first stirring chamber 43A and the second stirring chamber 44A.

In the developing roller chamber 42A, the developing roller 42 is arranged so as to face the electrophotographic photoreceptor 10. Although not shown in the figure, the developing roller 42 includes a magnetic roll (stationary magnet) having magnetism, and a sleeve provided on the outside of the magnetic roll. The developer in the first stirring chamber 43A is adsorbed onto a surface of the developing roller 42 by the magnetic force of the magnetic roll, and transported to the development region. A roller shaft of the developing roller 42 is rotatably supported by the developer container body 41A. Here, the developing roller 42 and the electrophotographic photoreceptor 10 are rotated in the same direction and, in a facing portion, the developer adsorbed onto the surface of the developing roller 42 is transported to the development region in a direction opposite to the traveling direction of the electrophotographic photoreceptor 10.

A bias power supply (not shown) is connected to the sleeve of the developing roller 42 so as to apply a developing bias. (In this exemplary embodiment, a bias in which an alternating-current component (AC) is superimposed on a direct-current component (DC) is applied so that an alternating electric field is applied to the development region.)

In the first stirring chamber 43A and the second stirring chamber 44A, a first stirring member 43 (stirring/transport member) and a second stirring member 44 (stirring/transport member) for transporting the developer while stirring are arranged, respectively. The first stirring member 43 includes a first rotation shaft extending in the axial direction of the developing roller 42, and a stirring transport blade (projected portion) which is fixed on an outer periphery of the rotation shaft in a spiral manner. Similarly, the second stirring member 44 also includes a second rotation shaft and a stirring transport blade (projected portion). Each of the stirring members is rotatably supported by the developer container body 41A. The first stirring member 43 and the second stirring member 44 are arranged so that the developer in the first stirring chamber 43A and the developer in the second stirring chamber 44A are transported in opposite directions by their rotation.

One end of the second stirring chamber 44A in a longitudinal direction is connected to an end of a developer transporting path 46 for supplying a supplemental developer containing a supplemental toner and a supplemental carrier to the second stirring chamber 44A. The supplemental developer container 47 containing the supplemental developer therein is connected to another end of the developer transporting path 46.

In this manner, the developing device 40 supplies the supplemental developer from the supplemental developer container (toner cartridge) 47 to the developing device 40 (second stirring chamber 44A) through the developer transporting path 46.

### Transfer Device

Examples of the first transfer device 51 and the second transfer device 52 include contact-type transfer-charging devices using a belt, a roller, a film, a rubber blade, or the like, and known transfer-charging devices such as a scorotron transfer-charging device and a corotron transfer-charging device that utilize corona discharge.

As the intermediate transfer member 50, a belt (intermediate transfer belt) composed of a conductive agent-containing polyimide, polyamide-imide, polycarbonate, polyarylate, polyester, rubber, or the like is used. The shape of the intermediate transfer member 50 may be a cylindrical shape instead of such a belt shape.

### Cleaning Device

The cleaning device 70 includes a housing 71 and a cleaning blade 72 arranged so as to protrude from the housing 71.

The cleaning blade 72 may be supported on an end of the housing 71. Alternatively, the cleaning blade 72 may be separately supported by a supporting member (holder). This exemplary embodiment describes a cleaning blade supported on an end of the housing 71.

The cleaning blade 72 will be described.

The cleaning blade 72 is a plate-shaped member extending in a direction of the rotation axis of the electrophotographic photoreceptor 10. The cleaning blade 72 is arranged at the upstream side of the rotation direction (arrow a) of the electrophotographic photoreceptor 10 so that an edge of the cleaning blade 72 contacts the electrophotographic photoreceptor 10 while applying a pressure.

Examples of the material of the cleaning blade 72 include urethane rubber, silicone rubber, fluororubber, chloroprene rubber, and butadiene rubber. Among these, urethane rubber is preferable.

The materials of the urethane rubber (polyurethane) are not particularly limited as long as, for example, the materials are usually used for forming polyurethanes. For example, a urethane prepolymer obtained from a polyol such as a polyester polyol, e.g., polyethylene adipate or polycaprolactone and an isocyanate such as diphenylmethane diisocyanate; and a crosslinking agent such as 1,4-butanediol, trimethylolpropane, ethylene glycol, or a mixture thereof may be used as the materials.

Next, an imaging process (a method for forming an image) using the image forming apparatus 101 according to this exemplary embodiment will be described.

In the image forming apparatus 101 according to this exemplary embodiment, first, the electrophotographic photoreceptor 10 is charged by the charging device 20 while rotating in the direction shown by the arrow a.

The electrophotographic photoreceptor 10, the surface of which has been charged by the charging device 20, is exposed by the exposure device 30, and a latent image is formed on the surface of the electrophotographic photoreceptor 10.

When a portion of the electrophotographic photoreceptor 10, on which the latent image has been formed, approaches the developing device 40, in the developing device 40, a magnetic brush formed of the developer and formed on the surface of the developing roller 42 contacts the electrophotographic photoreceptor 10. Thus, a toner adheres to the latent image to form a toner image.

When the electrophotographic photoreceptor 10, on which the toner image has been formed, further rotates in the direction shown by the arrow a, the toner image is transferred to the exterior surface of the intermediate transfer member 50.

After the toner image is transferred to the intermediate transfer member 50, a recording sheet P is supplied to the second transfer device 52 by the recording sheet supply device 53. The toner image, which has been transferred to the intermediate transfer member 50, is transferred to the recording sheet P by the second transfer device 52. Thus, the toner image is formed on the recording sheet P.

The toner image formed on the recording sheet P is fixed by the fixing device 80.

In this process, after the toner image is transferred to the intermediate transfer member 50, the toner and discharge products remaining on the surface of the electrophotographic photoreceptor 10 are removed by the cleaning blade 72 of the cleaning device 70. The electrophotographic photoreceptor 10, from which the toner and the discharge products remaining after the transfer have been removed by the cleaning device 70, is charged again by the charging device 20 and exposed by the exposure device 30. Thus, a latent image is again formed on the electrophotographic photoreceptor 10.

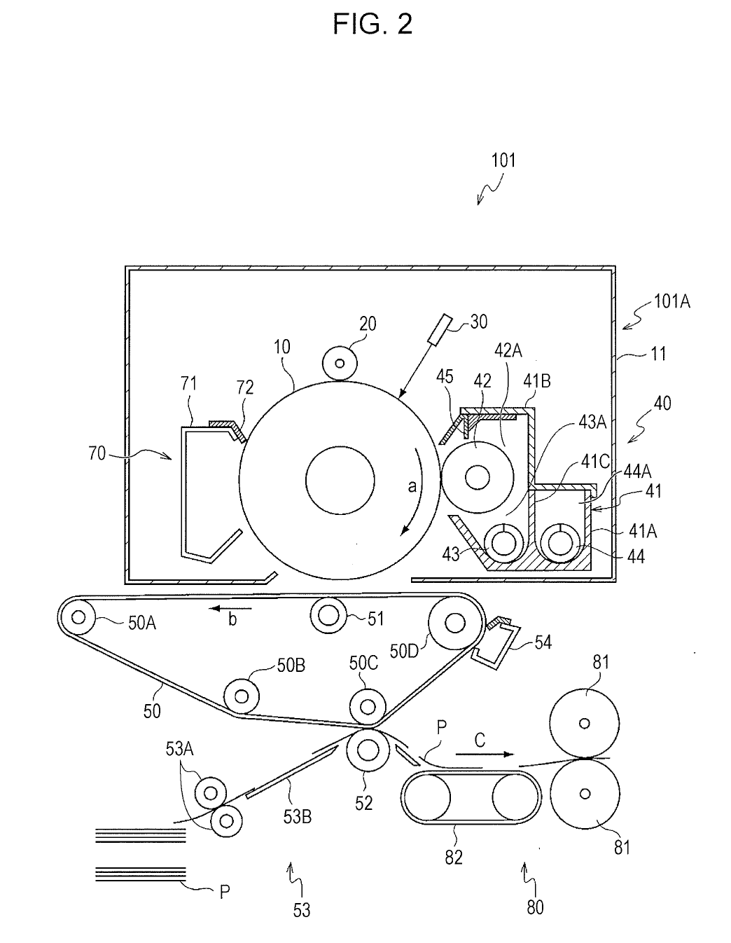

Alternatively, as illustrated in FIG. 2, for example, the image forming apparatus 101 according to this exemplary embodiment may include a process cartridge 101A in which the electrophotographic photoreceptor 10, the charging device 20, the developing device 40, and the cleaning device 70 are integrally arranged in a housing 11. This process cartridge 101A integrally contains plural members therein, and is attached to or detached from the image forming apparatus 101. The image forming apparatus 101 illustrated in FIG. 2 shows a configuration in which the developing device 40 does not include the supplemental developer container 47.

The configuration of the process cartridge 101A is not particularly limited as long as the process cartridge 101A includes at least the electrophotographic photoreceptor 10, the developing device 40, and the cleaning device 70. The process cartridge 101A may further include, for example, at least one device selected from the charging device 20, the exposure device 30, and the first transfer device 51.

The image forming apparatus 101 according to this exemplary embodiment is not limited to the above configuration. For example, a first charge-erasing device for making the polarity of the remaining toner uniform so that the remaining toner is easily removed by a cleaning brush or the like may be provided at the periphery of the electrophotographic photoreceptor 10 and on the downstream side of the first transfer device 51 in the rotation direction of the electrophotographic photoreceptor 10 and on the upstream side of the cleaning device 70 in the rotation direction of the electrophotographic photoreceptor 10. A second charge-erasing device for erasing charges on the surface of the electrophotographic photoreceptor 10 may be provided at the periphery of the electrophotographic photoreceptor 10 and on the downstream side of the cleaning device 70 in the rotation direction of the electrophotographic photoreceptor 10 and on the upstream side of the charging device 20 in the rotation direction of the electrophotographic photoreceptor 10.

The image forming apparatus 101 according to this exemplary embodiment is not limited to the above configuration and may have a known configuration. For example, a method in which a toner image formed on the electrophotographic photoreceptor 10 is directly transferred to a recording sheet P may be used, or a tandem-type image forming apparatus may be used.

### EXAMPLES

The present invention will now be specifically described by way of Examples, but the invention is not limited to these Examples. In Examples below, “part” refers to part by mass.

### [Preparation of Electrophotographic Photoreceptor]

### (Preparation of Electrophotographic Photoreceptor 1)

### Formation of Undercoat Layer

First, 100 parts by mass of zinc oxide (average particle diameter: 70 nm, manufactured by Tayca Corporation, specific surface area: 15 m²/g) is mixed with 500 parts by mass of toluene while stirring, 1.3 parts by mass of a silane coupling agent (KBM503, manufactured by Shin-Etsu Chemical Co., Ltd.) is added thereto, and the mixture is stirred for two hours. Toluene is then distilled off under reduced pressure, and the resulting product is baked at 120° C. for three hours to prepare silane coupling agent-surface-treated zinc oxide particles.

Next, 38 parts by mass of a solution prepared by dissolving 60 parts by mass of the surface-treated zinc oxide particles, 0.6 parts by mass of alizarin, 13.5 parts by mass of a curing agent (blocked isocyanate, Sumidur 3175 manufactured by Sumitomo Bayer Urethane Co., Ltd.), and 15 parts by mass of a butyral resin (S-LEC BM-1, manufactured by Sekisui Chemical Co., Ltd.) in 85 parts by mass of methyl ethyl ketone is mixed with 25 parts by mass of methyl ethyl ketone. The mixture is dispersed for two hours using glass beads having a diameter φ of 1 mm with a sand mill to prepare a dispersion liquid.

Next, 0.005 parts by mass of dioctyltin dilaurate as a catalyst and 40 parts by mass of silicone resin particles (Tospearl 145, manufactured by GE Toshiba Silicones Co., Ltd.) are added to the dispersion liquid to'prepare a coating liquid for forming an undercoat layer. This coating liquid is applied onto an aluminum base having a diameter of 30 mm by dip coating, and cured by drying at 170° C. for 40 minutes to form an undercoat layer having a thickness of 19 μm.

### Formation of Charge Generation Layer

A mixture of 15 parts by mass of hydroxygallium phthalocyanine (charge-generating material) having diffraction peaks at Bragg angles (2θ±0.2°) of at least 7.3°, 16.0°, 24.9°, and 28.0° in an X-ray diffraction spectrum obtained by using CuKα characteristic X-rays, 10 parts by mass of a vinyl chloride-vinyl acetate copolymer (binder resin) (VMCH, manufactured by Nippon Unicar Co., Ltd.), and 200 parts by mass of n-butyl acetate is dispersed using glass beads having a diameter φ of 1 mm with a sand mill for four hours. Next, 175 parts by mass of n-butyl acetate and 180 parts by mass of methyl ethyl ketone are added to the dispersion liquid, and the mixture is stirred to prepare a coating liquid for forming a charge generation layer. This coating liquid is applied onto the undercoat layer by dip coating, and dried at room temperature (25° C.) to form a charge generation layer having a thickness of 0.2 μm.

### Formation of Charge Transport Layer

First, 45 parts by mass of N,N′-diphenyl-N,N′-bis(3-methylphenyl)-[1,1′]biphenyl-4,4′-diamine and 55 parts by mass of a bisphenol Z polycarbonate resin (viscosity-average molecular weight: 50,000) are added to 800 parts by mass of chlorobenzene and dissolved therein to prepare a coating liquid for forming charge transport layer. This coating liquid is applied onto the charge generation layer, and dried at 130° C. for 45 minutes to form a charge transport layer having a thickness of 20 μm. Formation of protective layer

Five parts by mass of polytetrafluoroethylene particles (Lubron L-2, manufactured by Daikin Industries, Ltd.) and 0.25 parts by mass of a fluorinated alkyl group-containing copolymer having repeating units represented by structural formula (4) below (weight-average molecular weight: 50,000, 1:m=1:1, s=1, and n=60) are sufficiently mixed with 17 parts by mass of cyclopentanone (alicyclic ketone compound) while stirring to prepare a suspension of the polytetrafluoroethylene particles.

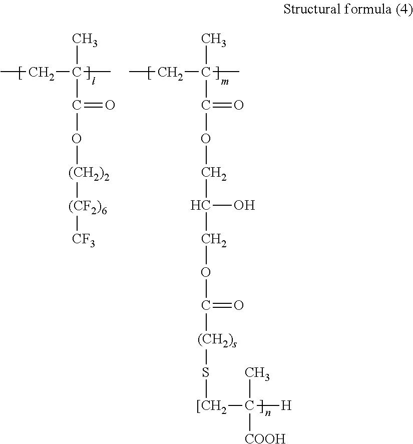

Next, 5 parts by mass of a melamine compound represented by formula (AM-1) below, and 95 parts by mass of a compound functioning as a charge-transporting material and represented by formula (I-1) below are added to 220 parts by mass of cyclopentanone, and sufficiently dissolved and mixed. The suspension of the polytetrafluoroethylene particles is then added thereto, and the mixture is mixed under stirring. A dispersion treatment at an increased pressure of 700 kgf/cm² is then repeated 20 times using a high-pressure homogenizer equipped with a flow-through chamber having a fine flow channel (YSNM-1500AR, manufactured by Yoshida Kikai Co., Ltd.). Subsequently, 0.2 parts by mass of a NACURE5225 (manufactured by King Industries Inc.) is added as a catalyst to prepare a coating liquid for forming a protective layer. This coating liquid is applied onto the charge transport layer by ring dip coating, and cured by heating at 150° C. for one hour to form a protective layer having a thickness of 4 μm. Thus, an electrophotographic photoreceptor 1 is prepared.

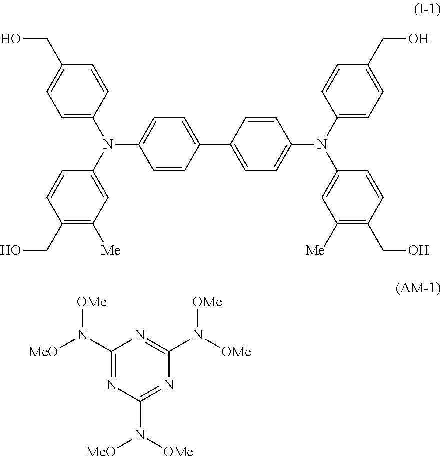

### [Preparation of Toners]

### (Preparation of Toner 1)

### Preparation of Polyester Resin Dispersion Liquid

| | |
|---|---|
| Terephthalic acid | 30% by mole |
| Fumaric acid | 70% by mole |
| Bisphenol A ethylene oxide 2-mole adduct | 20% by mole |
| Bisphenol A propylene oxide 2-mole adduct | 80% by mole |

The above monomers are put in a 5-L flask equipped with a stirrer, a nitrogen inlet tube, a temperature senor, and a rectifying column, and the temperature is increased to 190° C. over a period of one hour. Stirring of the reaction system is confirmed, and 1.2 parts by mass of dibutyltin oxide is then added to the flask.

The temperature is further increased from 190° C. to 240° C. over a period of six hours while distilling off water produced, and a dehydration-condensation reaction is further continued at 240° C. for three hours. Thus, an amorphous polyester resin 1 having an acid value of 12.0 mg/KOH, and a weight-average molecular weight of 9,700 is obtained.

Subsequently, the amorphous polyester resin 1 in the molten state is transported to a Cavitron CD1010 (manufactured by Eurotec Ltd.) at a rate of 100 g/min.

A 0.37 mass % diluted aqueous ammonia prepared by diluting an aqueous ammonia reagent with ion-exchange water is put in an aqueous medium tank that is separately prepared. The diluted aqueous ammonia is transported to the Cavitron CD1010 (manufactured by Eurotec Ltd.) while heating at 120° C. with a heat exchanger at a rate of 0.1 L/min at the same time of the transportation of the above molten amorphous polyester resin 1.

The Cavitron is operated under the conditions of a rotation speed of a rotator of 60 Hz and a pressure of 5 kg/cm². Thus, a resin dispersion liquid containing polyester resin particles having an average particle diameter of 0.16 μm, the dispersion liquid having a solid content of 30 parts by mass, is obtained. Preparation of colorant dispersion liquid

| | | |
|---|---|---|
| Cyan pigment (Copper phthalocyanine | 45 | parts by mass |
| B15:3, manufactured by Dainichiseika | | |
| Color & Chemicals Mfg. Co., Ltd.) | | |
| Ionic surfactant Neogen RK | 5 | parts by mass |
| (manufactured by Dai-ichi Kogyo | | |
| Seiyaku Co., Ltd.) | | |
| Ion-exchange water | 200 | parts by mass |

The above components are mixed and dissolved, and dispersed for 10 minutes with a homogenizer (IKA Ultra-Turrax) to prepare a colorant dispersion liquid having a median particle diameter of 168 nm and a solid content of 22.0 parts by mass.

### Preparation of Releasing Agent Dispersion Liquid

| | | |
|---|---|---|
| Paraffin wax HNP9 (melting point: | 45 | parts by mass |
| 75° C., manufactured by Nippon | | |
| Seiro Co., Ltd.) | | |
| Cationic surfactant Neogen RK | 5 | parts by mass |
| (manufactured by Dai-ichi Kogyo | | |
| Seiyaku Co., Ltd.) | | |
| Ion-exchange water | 200 | parts by mass |

The above components are heated to 95° C., and dispersed using Ultra-Turrax T50 manufactured by IKA. A dispersion treatment is then conducted with a pressure discharging-type Gaulin homogenizer to prepare a releasing agent dispersion liquid having a median diameter of 200 nm and a solid content of 20.0 parts by mass.

### Preparation of Toner Particles

| | | |
|---|---|---|
| Polyester resin dispersion liquid | 278.9 | parts by mass |
| Colorant dispersion liquid | 27.3 | parts by mass |
| Releasing agent dispersion liquid | 35 | parts by mass |

The above dispersion liquids are mixed and dispersed in a round stainless flask using Ultra-Turrax T50. Next, 0.20 parts by mass of polyaluminum chloride is added thereto, the dispersion operation is continued with the Ultra-Turrax. The flask is heated to 48° C. in an oil bath for heating while stirring. The temperature is maintained at 48° C. for 60 minutes, and 70.0 parts by mass of the resin dispersion liquid is then further added to the flask.

Subsequently, the pH in the reaction system is adjusted to be 9.0 with a 0.5 mol/L aqueous sodium hydroxide solution. The stainless flask is then sealed, and heated to 96° C. while the stirring is continued using a magnetic seal. The flask is maintained in this state for five hour.

After the completion of the reaction, the content of the flask is cooled, filtrated, and washed with ion-exchange water. The product is then subjected to solid-liquid separation by Nutsche suction filtration. The solid is further re-dispersed in 1 L of ion-exchange water at 40° C., and the resulting dispersion liquid is stirred at 300 rpm for 15 minutes for washing.

The above washing process is further repeated five times. When the pH of the filtrate becomes 7.5 and the electrical conductivity thereof becomes 7.0 μS/cm, solid-liquid separation is conducted by Nutsche suction filtration using No. 5A filter paper. Vacuum drying is then continued for 12 hours.

The particle diameter of the prepared particles is measured with a Coulter Multisizer. The volume-average particle diameter D50 is 3.6 μm, and the particle size distribution index GSD is 1.14. The shape factor of the toner particles determined by a particle shape observation with a LUZEX is 0.970.

### Preparation of External Additive.

Silica particles having an average primary particle diameter of 100 nm and an amount of surface treatment with dimethyl silicone oil of 5% by mass are prepared by a sol-gel method.

### Preparation of Toner

To 100 parts by mass of the toner particles, 3 parts by mass of the silica particles and 1 part by mass of silica particles (R972, manufactured by Nippon Aerosil Co., Ltd.) are added. The mixture is blended with a 5-L Henschel mixer at a peripheral velocity of 30 m/s for 15 minutes. Coarse particles are then removed with a sieve having openings of 45 μm to prepare toner 1.

### (Preparation of Toner 2)

Toner particles are prepared as in toner 1 except that, in preparation of the toner particles, the temperature of the flask is increased to 41° C. in the oil bath for heating under stirring, and the temperature is maintained at 41° C. for 60 minutes.

The prepared toner has a volume-average particle diameter D50 of 3.0 μm, and a particle size distribution index GSD of 1.18. The shape factor of the toner particles determined by a particle shape observation with a LUZEX is 0.969.

Toner 2 is prepared as in toner 1 using the prepared toner, particles.

### (Preparation of Toner 3)

Toner particles are prepared as in toner 1 except that, in preparation of the toner particles, the temperature of the flask is increased to 55° C. in the oil bath for heating under stirring, and the temperature is maintained at 55° C. for 60 minutes.

The prepared toner has a volume-average particle diameter D50 of 6.1 μm, and a particle size distribution index GSD of 1.12. The shape factor of the toner particles determined by a particle shape observation with a LUZEX is 0.972.

Toner 3 is prepared as in toner 1 using the prepared toner particles.

### [Preparation of Carriers]

### (Preparation of Carrier 1)

| | | |
|---|---|---|
| Polymethyl methacrylate (PMMA) resin | 3 | parts by mass |
| (manufactured by Soken Chemical & | | |
| Engineering Co., Ltd., Mw: 72,000, Mn: 36,000) | | |
| Toluene (analytical grade) (manufactured | 30 | parts by mass |
| by Wako Pure Chemical Industries Ltd.) | | |
| Core material [magnetic powder | 100 | parts by mass |
| manufactured by Powdertech Co., Ltd., | | |
| Mn—Mg ferrite core (average particle | | |
| diameter: 25 μm, saturation magnetization: | | |
| 55 A · m²/kg (at 1 kOe), true specific | | |
| gravity: 4.6 g/cm³)] | | |

First, among the above components, the PMMA resin is dissolved in toluene to prepare a toluene solution of the PMMA resin.

Next, the ferrite core (magnetic powder) used as a core material is put in a kneader heated at 80° C., and blended.

When the temperature of the ferrite core reaches 50° C., the toluene solution of the PMMA resin is put in the kneader. The kneader is sealed, and the ferrite core and the toluene solution of the PMMA resin are blended for 10 minutes.

Next, the atmosphere in the kneader is evacuated while blending so as to evaporate toluene. Thirty minutes later, vacuum is released, and the resulting powder is taken out from the kneader.

The powder is left to cool to 30° C., and 45-μm sieving is then performed, thus preparing carrier 1.

### (Preparation of Carrier 2)

Carrier 2 is prepared as in carrier 1, except that core material (ferrite core [true specific gravity: 4.6], magnetic powder) whose magnetization and particle diameter are adjusted so that a carrier to be obtained has the magnetization and the particle diameter shown in Table 1 is used.

### (Preparation of Carrier 3)

Carrier 3 is prepared as in carrier 1, except that a core material (ferrite core [true specific gravity: 4.6], magnetic powder) whose magnetization and particle diameter are adjusted so that a carrier to be obtained has the magnetization and the particle diameter shown in Table 1 is used.

### (Preparation of Carrier 4)

Carrier 4 is prepared as in carrier 1, except that a core material (magnetic powder) whose magnetization and particle diameter are adjusted so that a carrier to be obtained has the magnetization and the particle diameter shown in Table 1 is used,.

A magnetic powder-dispersed core (core manufactured by Toda Kogyo Corp., true specific gravity: 3.6) is used as the core material (magnetic powder).

### (Preparation of Carrier 5)

Carrier 5 is prepared as in carrier 1, except that a core material (magnetic powder) whose magnetization and particle diameter are adjusted so that a carrier to be obtained has the magnetization and the particle diameter shown in Table 1 is used, and the amount of PMMA resin, which is the amount of resin coating, is 2.2 parts by mass.

A magnetic powder-dispersed core (core manufactured by Toda Kogyo Corp., true specific gravity: 3.6) is used as the core material (magnetic powder).

### (Preparation of Carrier 6)

Carrier 6 is prepared as in carrier 1, except that a core material (ferrite core [true specific gravity: 4.6], magnetic powder) whose magnetization and particle diameter are adjusted so that a carrier to be obtained has the magnetization and the particle diameter shown in Table 1 is used.

### (Preparation of Carrier 7)

Carrier 7 is prepared as in carrier 1, except that a core material (magnetic powder) whose magnetization and particle diameter are adjusted so that a carrier to be obtained has the magnetization and the particle diameter shown in Table 1 is used, and the amount of PMMA resin, which is the amount of resin coating, is 1.5 parts by mass.

A magnetic powder-dispersed core (core manufactured by Toda Kogyo Corp., true specific gravity: 3.6) is used as the core material (magnetic powder).

### (Preparation of Comparative Carrier 1)

Comparative carrier 1 is prepared as in carrier 1, except that a core material (ferrite core [true specific gravity: 4.6], magnetic powder) whose magnetization and particle diameter are adjusted so that a carrier to be obtained has the magnetization and the particle diameter shown in Table 1 is used.

### (Preparation of Comparative Carrier 2)

Comparative carrier 2 is prepared as in carrier 1, except that a core material (magnetic powder) whose magnetization and particle diameter are adjusted so that a carrier to be obtained has the magnetization and the particle diameter shown in Table 1 is used.

A magnetic powder-dispersed core (core manufactured by Toda Kogyo Corp., true specific gravity: 3.6) is used as the core material (magnetic powder).

### (Preparation of Comparative Carrier 3)

Comparative carrier 3 is prepared as in carrier 1, except that a core material (ferrite core [true specific gravity: 4.6], magnetic powder), whose magnetization and particle diameter are adjusted so that a carrier to be obtained has the magnetization and the particle diameter shown in Table 1 is used.

Characteristics of the prepared carriers are listed in Table 1.

### [Examples 1 to 10 and Comparative Examples 1 to 5]

A toner and a carrier in combination shown in Table 2 are blended with a V-blender for five minutes so that a mass ratio of the toner to the carrier is 8%. Thus, developers are prepared.

The prepared developer and the electrophotographic photoreceptor as detailed in Table 2 are installed in a developing device of an image forming apparatus “modified 700 Digital Color Press” manufactured by Fuji Xerox Co., Ltd., and evaluations are conducted. The evaluation results are shown in Table 2. The evaluations are conducted at a black development position of the modified 700 Digital Color Press.

The conditions of the apparatus are set as described below. Herein, numerical ranges and conditions in parentheses of the conditions of the apparatus described below are ranges of conditions under which at least the same evaluation results are obtained.

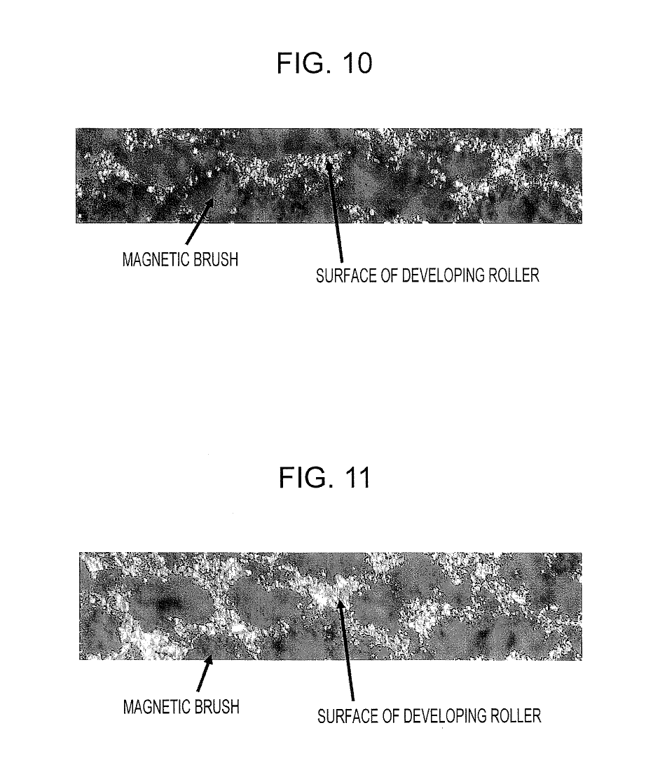

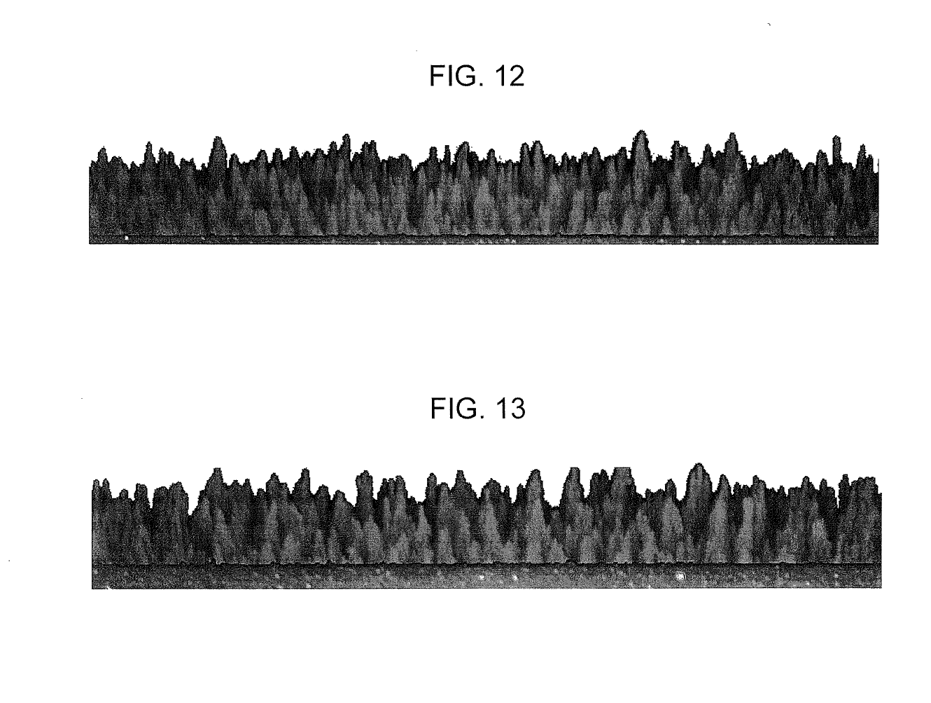

FIGS. 10 and 12 are schematic views of a magnetic brush in Example 1, when viewed from an end thereof and from a side surface thereof, respectively. FIGS. 11 and 13 are schematic views of a magnetic brush in Comparative Example 1, when viewed from an end thereof and from a side surface thereof, respectively.

### (Evaluations)

### Brush Roughness Rz_{JIS} of Magnetic Brush

A brush roughness Rz_{JIS} of a magnetic brush is measured.

### Streak-Like Fog

Streak-like fog on the background is evaluated using a chart having a thin line with a width of 1 mm in a central part thereof.

Specifically, a developed image on the electrophotographic photoreceptor is subjected to tape transfer up to both ends of the photoreceptor in an axial direction using Scotch mending tape 810-3-24 manufactured by Sumitomo 3M Ltd. The transferred image is applied onto an overhead projector (OHP) manufactured by Fuji Xerox Co., Ltd., and the density of the image is measured with an X-Rite. The density is measured at 10 positions from an end of the photoreceptor at intervals of 2.5 cm.

The density of the tape itself, which is applied onto the OHP as it is, is measured in advance in the same manner. The average in this measurement is defined as a tape density.

The density is calculated as a density delta (A) value by the following formula:

Density Δ value=(tape-transfer density)−(tape density)

The grades of the density A value are determined from the average of the total of 10 positions.

The evaluation criteria are as follows. When the density Δ value is less than 0.01, fog on paper after transfer is not visually observed, and thus the result is evaluated as “acceptable”. When the density Δ value is equal to or greater than 0.01, the result is evaluated as “non-acceptable”.
G1: The density Δ value is equal to or less than 0.002.
G2: The density Δ value is 0.003 or more and 0.005 or less.
G3: The density Δ value is 0.006 or more and 0.009 or less.
G4: The density Δ value is 0.01 or more and 0.02 or less.
G5: The density Δ value is more than 0.02.

The streak-like fog is evaluated at an initial stage (in the first image) and after the lapse of time (in the 50,000th image).

### Carrier Scattering

Carrier scattering is evaluated as follows. A solid image is output over the entire surface of an A3 size sheet. The number of carriers and the number of print defects in terms of image density on the image are counted using a loupe with a magnification of 50 times. The total of the number of scattered carriers on ten A3 size sheets is shown in Table 2.

The evaluation criteria are as follows. When the number of scattered carriers is 9 or less per ten A3 size sheets, the result is evaluated as “acceptable”. When the number of scattered carriers is 10 or more per ten A3 size sheets, the result is evaluated as “non-acceptable”.
G1: The number of scattered carriers is 0.
G2: The number of scattered carriers is 1 or more and 3 or less.
G3: The number of scattered carriers is 4 or more and 9 or less.
G4: The number of scattered carriers is 10 or more and 30 or less.
G5: The number of scattered carriers is more than 30.

### (Conditions of Apparatus)

### Cleaning Conditions

Rubber hardness of cleaning blade: 80° (70° or more and 85° or less)
Modulus of repulsion elasticity of rubber of cleaning blade: 45% (20% or more and 55% or less)
Contact angle of cleaning blade to photoreceptor: 10° (10° or more and 30° or less)
Linear pressure of cleaning blade to photoreceptor: 2.7 gf/mm (2 gf/mm or more and 4 gf/mm or less)

### Developing Conditions

Facing distance between. developing roller and photoreceptor (DRS): 300 μm (200 μm or more and 600 μm or less)
Amount of developer on developing roller (MOS): 400 g/m² (200 g/m² or more and 600 g/m² or less)
Rotational speed of developing roller (process speed): 330 mm/sec (50 mm/sec or more and 1,500 mm/sec or less)
Rotation direction of developing roller (MRS): the same direction as photoreceptor (with direction) and at a peripheral velocity ratio of 1.7 (the same direction as photoreceptor (with direction) and at a peripheral velocity ratio of 1.0 or more and 3.0 or less, or direction opposite to photoreceptor (against direction) and at a peripheral velocity ratio of 0.6 or more and 2.0 or less)
Surface shape and roughness of developing roller: sandblasting Rz 25 μm (10 μm or more and 50 μm or less), groove sleeve 0.8 mm pitch (0.2 mm pitch or more and 2 mm pitch or less)
Diameter of developing roller: φ 18 mm (φ 10 mm or more and φ 40 mm or less)
Magnetic force of development pole on developing roller: 125 mT (50 mT or more and 150 mT or less)
Magnet set angle (MSA) of developing roller: upstream side 3° (3°−10° or more and 3°+10° or less)
DC component voltage of voltage applied to developing roller: 550 V (300 V or more and 650 V or less)
Difference between DC component voltage of voltage applied to developing roller and photoreceptor surface potential corresponding to background of image (Vcln): 125 V (50 V or more and 200 V or less)
AC component voltage (developing AC bias) waveform superimposed on DC component voltage (DC) applied to developing roller: sine wave (rectangular wave)
Amplitude of developing AC bias (Vp-p: peak to peak voltage): 0.75 kV (0 kV or more and 2.0 kV or less)
Proportion of AC component voltage in applied voltage (developing AC bias duty): 50% (20% or more and 80% or less) Frequency of developing AC bias: 10 kHz (3 kHz or more and 40 kHz or less)
Diameter of photoreceptor:φ 84 mm (φ 30 mm or more and 168 mm or less)

TABLE 1

| | | | | | | Carrier particle | |
|---|---|---|---|---|---|---|---|
| | | | | | | size distribution | |
| | Average | | | | | Proportion of | |
| | magnetization | | | | True specific | carrier particles | |
| | per carrier | Amount of | Volume-average | Magnetization | gravity of | having particle | |
| | particle | resin coating | particle diameter | of carrier | core material | diameter of 45 μm | |
| | (Am²/particle) | (parts by mass) | of carrier (μm) | (Am²/kg) | (g/cm³) | or more (%) | Core material |
| Carrier 1 | 2.07E−15 | 3.0 | 25 | 55 | 4.6 | 1.2 | Ferrite core |
| Carrier 2 | 2.92E−15 | 3.0 | 30 | 45 | 4.6 | 2.4 | Ferrite core |
| Carrier 3 | 6.36E−16 | 3.0 | 20 | 33 | 4.6 | 0.6 | Ferrite core |
| Carrier 4 | 2.67E−15 | 3.0 | 35 | 33 | 3.6 | 3.2 | Magnetic powder- |
| | | | | | | | dispersed core |
| Carrier 5 | 1.18E−15 | 2.2 | 23 | 58 | 3.6 | 1 | Magnetic powder- |
| | | | | | | | dispersed core |
| Carrier 6 | 2.33E−15 | 3.0 | 26 | 55 | 4.6 | 9.2 | Ferrite core |
| Carrier 7 | 1.16E−15 | 1.5 | 22 | 58 | 3.6 | 0.2 | Magnetic powder- |
| | | | | | | | dispersed core |
| Comparative | 5.68E−15 | 3.0 | 35 | 55 | 4.6 | 7.4 | Ferrite core |
| Carrier 1 | | | | | | | |
| Comparative | 3.23E−15 | 3.0 | 35 | 40 | 3.6 | 2.1 | Magnetic powder- |
| Carrier 2 | | | | | | | dispersed core |
| Comparative | 2.84E−16 | 3.0 | 14 | 43 | 4.6 | 0.2 | Ferrite core |
| Carrier 3 | | | | | | | |

TABLE 2

| | | | | Brush | | | | |
|---|---|---|---|---|---|---|---|---|
| | | | | roughness | | | | |
| | Developer | | | of magnetic | Streak-like fog | | | |
| | Type of | | Type of | brush Rz_{JIS} | | After lapse | Carrier | |
| | Toner | Type of carrier | photoreceptor | (μm) | Initial | of time | scattering | Remarks |
| Example 1 | 1 | 1 | 1 | 650 | G1 | G1 | G1 | Acceptable |
| Example 2 | 1 | 2 | 1 | 830 | G3 | G3 | G1 | Acceptable |
| Example 3 | 1 | 3 | 1 | 350 | G1 | G1 | G3 | Acceptable |
| Example 4 | 1 | 4 | 1 | 790 | G1 | G2 | G1 | Acceptable |
| Example 5 | 1 | 5 | 1 | 480 | G1 | G2 | G2 | Acceptable |
| Example 6 | 1 | 6 | 1 | 670 | G1 | G3 | G1 | Acceptable |
| Example 7 | 1 | 7 | 1 | 470 | G1 | G3 | G2 | Acceptable |
| Example 8 | 2 | 1 | 1 | 645 | G2 | G2 | G1 | Acceptable |
| Example 9 | 2 | 2 | 1 | 820 | G3 | G3 | G1 | Acceptable |
| Example 10 | 3 | 2 | 1 | 835 | G2 | G2 | G1 | Acceptable |
| Comparative | 1 | Comparative 1 | 1 | 1,400 | G4 | G5 | G1 | Non-acceptable |
| Example 1 | | | | | | | | |
| Comparative | 1 | Comparative 2 | 1 | 890 | G3 | G4 | G1 | Non-acceptable |
| Example 2 | | | | | | | | |
| Comparative | 1 | Comparative 3 | 1 | 270 | G1 | G2 | G4 | Non-acceptable |
| Example 3 | | | | | | | | |
| Comparative | 2 | Comparative 2 | 1 | 880 | G4 | G4 | G1 | Non-acceptable |
| Example 4 | | | | | | | | |
| Comparative | 3 | Comparative 1 | 1 | 1,420 | G3 | G4 | G1 | Non-acceptable |
| Example 5 | | | | | | | | |

The above results show that, in Examples, good results are obtained in the evaluation of streak-like fog, as compared with Comparative Examples.

In Comparative Examples, when a cured film containing fluorocarbon resin particles is used as the top surface layer of the photoreceptor, streak-like fog is generated as described above.

The mechanism behind this generation of streak-like fog is believed to be as follows. Exposed fluorocarbon resin particles are spread by the cleaning blade only in the circumferential direction of the photoreceptor without being spread in the axial direction thereof, and are thus applied in streak-like shapes. More specifically, the fluorocarbon resin is not applied over the entire surface of the photoreceptor, and regions where the fluorocarbon resin is not applied are formed in streak-like shapes in the circumferential direction of the photoreceptor.

It is believed that, since a toner having a small particle diameter is used in such a state, the generation of streak-like fog significantly appears on regions of an image where the fluorocarbon resin is not applied because the non-electrostatic adhesive force of the toner having the small particle diameter to the photoreceptor is large.

In contrast, in Examples, the brush roughness of the magnetic brush formed of the electrostatic latent image developer and formed on the surface of the developing roller is controlled to be 300 μm or more and 850 μm or less, or about 300 μm or more and about 850 μm or less. This means that the density of the magnetic brush is high and the length of the brush is even.

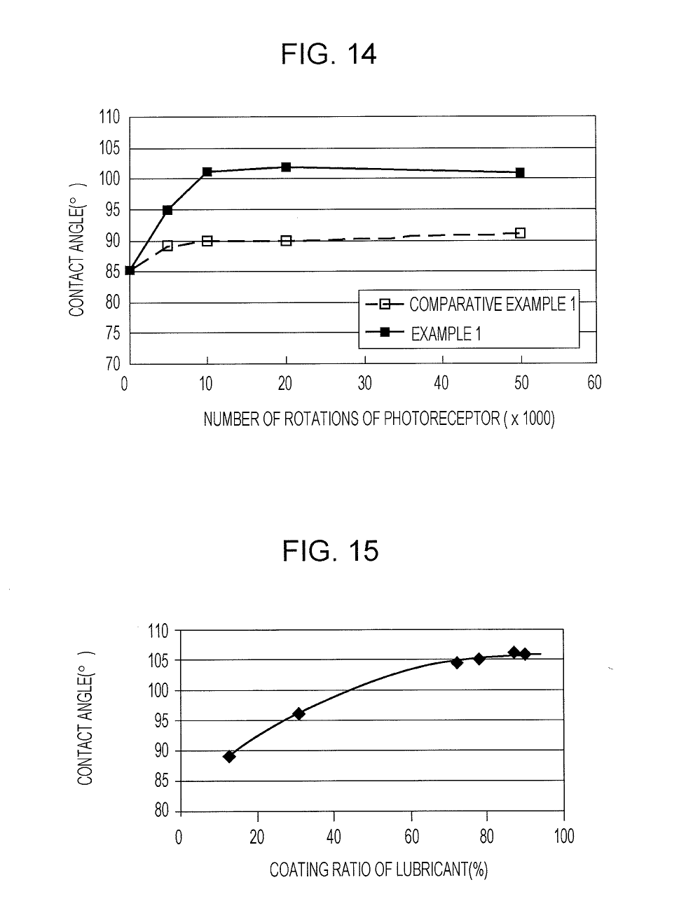

Such a magnetic brush has a high density and an even brush length. Therefore, in the development, the probability in which the magnetic brush contracts a fluorocarbon resin applied onto the photoreceptor in streak-like shapes, the fluorocarbon resin being formed of fluorocarbon resin particles exposed by the cleaning blade, increases. It is believed that, consequently, the fluorocarbon resin applied onto the photoreceptor in streak-like shapes is applied so as to spread in the axial direction of the photoreceptor by vibrations of the magnetic brush in the axial direction of the photoreceptor. It is believed that, as a result, the fluorocarbon resin is easily uniformly applied over the entire surface of the photoreceptor. This function is also confirmed from the results of contact angle of the surface of the photoreceptor (contact angle to water), the results showing that the fluorocarbon resin is exposed and widely applied, as illustrated in FIGS. 14 and 15.

FIG. 14 is a graph showing a relationship between the number of rotations of a photoreceptor and a contact angle of a surface of the photoreceptor (contact angle to water) in Example 1 and Comparative Example 1. Referring to FIG. 14, in Example 1, the contact angle of the surface of the photoreceptor is increased in accordance with the number of rotations of the photoreceptor, as compared with Comparative Example 1.

FIG. 15 is a graph showing a relationship between the coating ratio of a lubricant to a surface of a photoreceptor and a contact angle of the surface of the photoreceptor (contact angle to water). FIG. 15 shows that, with an increase in the coating ratio of the lubricant, the contact angle of the surface of the photoreceptor also increases.

It is believed that the formation of a magnetic brush having a brush roughness in the above range and achieving this advantage is realized by using the above-described weakly magnetized carrier.

The reason for this is believed to be as follows. In the case where such a weakly magnetized carrier is used, when a developer carried on a developing roller enters a development region (region where the photoreceptor faces the developing roller), linked carrier particles are easily disconnected or easily slide in the development region because the action of the attractive force between the carrier particles is small. As a result, rearrangement of the carrier particles easily occurs, and the density of the magnetic brush becomes high (refer to FIG. 4). In addition, it is believed that the length of the magnetic brush becomes easily even. Accordingly, when the weakly magnetized carrier is used, the magnetic brush having a brush roughness in the above range is believed to be formed.

As described above, when a top surface layer composed of a cured film containing fluorocarbon resin particles is used in a photoreceptor, streak-like fog is generated by a combination of the top surface layer and the above-described toner having a small particle diameter. This problem is addressed by realizing a roughness of a magnetic brush within a specific range, the magnetic brush being formed of an electrostatic latent image developer, by controlling the average magnetization per carrier particle.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic latent image developer comprising:
a toner having a volume-average particle diameter of about 2.0 μm or more and about 6.5 μm or less; and
a carrier whose average magnetization per carrier particle at an applied magnetic field of 1 kilooersted is about 3.0×10⁻¹⁶ A²/particle or more and about 3.0×10⁻¹⁵ Am²/particle or less,
wherein the electrostatic latent image developer is used in an image forming apparatus including
an image-carrying member having a top surface layer composed of a cured film containing fluorocarbon resin particles,
a charging unit that charges a surface of the image-carrying member,
a latent image-forming unit that exposes the charged surface of the image-carrying member to form an electrostatic latent image,
a developing unit that contains an electrostatic latent image developer therein and that includes a developer-carrying member, the developing unit being configured to develop the electrostatic latent image formed on the image-carrying member to form a toner image by bringing a magnetic brush formed on the surface of the developer-carrying member into contact with the image-carrying member, the magnetic brush being formed of the electrostatic latent image developer and having a brush roughness of about 300 μm or more and about 850 μm or less,
a transfer unit that transfers the toner image formed on the image-carrying member to a recording medium, and
a cleaning unit that includes a cleaning blade configured to contact the surface of the image-carrying member to clean the surface of the image-carrying member.

2. A method for forming an image comprising:
charging a surface of an image-carrying member having a top surface layer composed of a cured film containing fluorocarbon resin particles;
forming an electrostatic latent image by exposing the charged surface of the image-carrying member;
developing the electrostatic latent image formed on the image-carrying member to form a toner image by forming a magnetic brush on a developer-carrying member, and bringing the magnetic brush into contact with the image-carrying member;
transferring the toner image formed on the image-carrying member to a recording medium; and
cleaning the surface of the image-carrying member with a cleaning blade,
wherein the magnetic brush is formed of an electrostatic latent image developer containing a toner having a volume-average particle diameter of about 2.0 μm or more and about 6.5 μm or less and a carrier whose average magnetization per carrier particle at an applied magnetic field of 1 kilooersted is about 3.0×10⁻¹⁶ Am²/particle or more and about 3.0×10⁻¹⁵ Am^{t}/particle or less, and has a brush roughness of about 300 μm or more and about 850 μm or less.

3. An image forming apparatus comprising:
an image-carrying member having a top surface layer composed of a cured film containing fluorocarbon resin particles;
a charging unit that charges a surface of the image-carrying member;
a latent image-forming unit that exposes the charged surface of the image-carrying member to form an electrostatic latent image;
a developing unit that contains an electrostatic latent image developer therein and that includes a developer-carrying member, the developing unit being configured to develop the electrostatic latent image formed on the image-carrying member to form a toner image by bringing a magnetic brush formed on the surface of the developer-carrying member and formed of the electrostatic latent image developer into contact with the image-carrying member;
a transfer unit that transfers the toner image formed on the image-carrying member to a recording medium; and
a cleaning unit that includes a cleaning blade configured to contact the surface of the image-carrying member to clean the surface of the image-carrying member,
wherein the electrostatic latent image developer contains a toner having a volume-average particle diameter of about 2.0 μm or more and about 6.5 μm or less and a carrier whose average magnetization per carrier particle at an applied magnetic field of 1 kilooersted is about 3.0×10⁻¹⁶ Am²/particle or more and about 3.0×10⁻¹⁵ Am²/particle or less, and
the magnetic brush has a brush roughness of about 300 μm or more and about 850 μm or less.
